(19) United States
(12) Patent Application Publication
(10) Pub. No.: US 2024/0376291 A1
(43) Pub. Date: Nov. 14, 2024

(54) EPOXY RESIN COMPOSITION, FILM, METHOD FOR PRODUCING FILM, AND CURED PRODUCTS

(71) Applicant: ASAHI KASEI KABUSHIKI KAISHA, Tokyo (JP)

(72) Inventors: Naohiro KOBAYASHI, Tokyo (JP); Masanori YOSHIDA, Tokyo (JP); Kenzo ONIZUKA, Tokyo (JP)

(73) Assignee: ASAHI KASEI KABUSHIKI KAISHA, Tokyo (JP)

(21) Appl. No.: 18/578,389

(22) PCT Filed: Jun. 8, 2022
(86) PCT No.: PCT/JP2022/023186

§ 371 Date: Jan. 11, 2024

(30) Foreign Application Priority Data
Jul. 12, 2021 (JP) 2021-114776
Aug. 18, 2021 (JP) 2021-133229

(51) Int. Cl. C08K 5/13; C08G 59/22; C08G 59/24; C08G 59/50; C08J 5/18

(52) U.S. Cl. CPC C08K 5/13; C08G 59/223; C08G 59/226; C08G 59/245; C08G 59/50; C08J 5/18; C08J 2363/02

(57) ABSTRACT

The present invention provides an epoxy resin composition containing:
a component (A): epoxy resin;
a component (B): microcapsular curing agent;
a component (C): reactive diluent; and
a component (D): compound represented by formula (1) below:

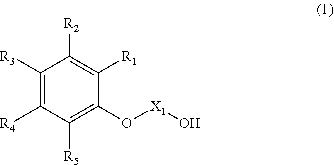

wherein X₁ has 2 or more and 5 or less consecutive carbon-carbon bonds, and a substituent of carbon contained in X₁ and R₁ to R₅ are each one selected from the group consisting of hydrogen, an alkyl group, an unsaturated aliphatic group, an aromatic group, a heteroatom-containing substituent, a halogen atom-containing substituent, and a halogen atom; the substituent of carbon contained in X₁ and R₁ to R₅ are the same as or different from each other; and the compound is optionally a fused ring compound in which any of R₁ to R₅ are present in the same ring.

### TECHNICAL FIELD

The present invention relates to an epoxy resin composition, a film, a method for producing the film, and cured products.

### BACKGROUND ART

Conventionally, epoxy resins have been used in a wide range of applications, such as insulating materials for electrical and electronic components, sealing materials, adhesives, electroconductive materials, matrix resins for fiber-reinforced plastics, and impregnating and fixing agents for motor coils.

The recent requirements for electronic device equipment are diverse, including miniaturization, higher functionality, lighter weight, and multifunctionality, and in the mounting technology of semiconductor chips as well, the finer pitch of electrode pads and pad pitches has led to further miniaturization, downsizing, and higher density, while the size of semiconductor chips has also been increasing. In the gap between the semiconductor chip and the substrate, there is an underfill material that protects the bump connection area and the circuit surface of the chip, and an epoxy resin composition is used as the underfill material.

As the epoxy resin composition applicable to the underfill material, for example, a one-component epoxy resin composition has been disclosed that contains microencapsulated amine/epoxy adduct particles and a reactive diluent, and that is excellent in storage stability, curing characteristics, physical properties of the cured product, and low viscosity (see, for example, Patent Document 1).

Also, for example, a one-component epoxy resin composition has been disclosed that contains a microcapsular curing agent with a core of curing agent for epoxy resins containing two or more amine compounds and a thermosetting liquid resin with a viscosity at 25° C. of 0.03 Pa·s or more and less than 3 Pa·s, and that is excellent in storage stability, low-temperature curability, and gap permeability (see, for example, Patent Document 2).

### CITATION LIST

### Patent Document

Patent Document 1: Japanese Patent No. 3454437
Patent Document 2: Japanese Patent No. 6085130

### SUMMARY OF INVENTION

### Technical Problem

In recent years, underfill materials for the gap between semiconductor chips and substrates, such as those mentioned above, have been required to have low viscosity in order to enable sufficient permeation in a short time to cope with larger area due to larger size of semiconductor chips and to cope with narrower gap associated with finer pitch of semiconductor chips. In addition, the underfill materials have been required to have curability at a low temperature, such as sufficient curability at around 100° C., in order to reduce the influence on the constituent members of semiconductor chips.

Furthermore, the underfill materials have been required to be one-component epoxy resin compositions that can omit the mixing process at the time of use from the viewpoint of productivity improvement, but one-component epoxy resin compositions are required to have high storage stability since the epoxy resin and the curing agent are integrated.

That is, there is a need for a one-component epoxy resin composition that simultaneously possesses high levels of low viscosity, sufficient curability at around 100° C., and high storage stability.

Also, in recent years, as electronic materials become smaller and thinner, films using epoxy resin compositions have become increasingly important for the purpose of making adhesive layer and insulating layer thinner. In order to obtain the aforementioned films, a coating liquid is produced in which components such as epoxy resin, curing agent, curing accelerator, and polymer for film formation are dissolved in a solvent, the coating liquid is applied onto a specific support, and then drying treatment is performed to produce the films. Therefore, the aforementioned coating liquid is strongly required to have storage stability as a coating liquid, stability during the film production process when applying and drying the coating liquid, and stability in the film state.

With respect to the various requirements for epoxy resin compositions as mentioned above, the one-component epoxy resin compositions disclosed in Patent Documents 1 and 2 have problems that there is still room for improvement in terms of achieving both curability and storage stability, and also that there is still room for improvement in terms of stability during the production process of films using these epoxy resin compositions and stability in the film state.

Thus, in view of the problems of the prior art mentioned above, an object of the present invention is to obtain an epoxy resin composition that simultaneously expresses low viscosity, sufficient curability at around 100° C., and excellent storage stability, as well as to provide an epoxy resin composition that is excellent in stability during the production process of a film using the epoxy resin composition and stability in the film state.

### Solution to Problem

As a result of diligent investigations, the present inventors have found that the above-described object can be achieved by the following technical means, thereby leading to completion of the present invention.

That is, the present invention is as follows.
[1] An epoxy resin composition containing:
a component (A): epoxy resin;
a component (B): microcapsular curing agent;
a component (C): reactive diluent; and
a component (D): compound represented by formula (1) below:

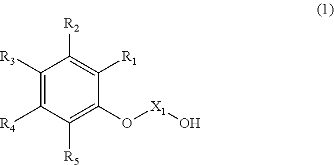

wherein X₁ has 2 or more and 5 or less consecutive carbon-carbon bonds, and a substituent of carbon contained in X₁ and R₁ to R₅ are each one selected from the group consisting of hydrogen, an alkyl group, an unsaturated aliphatic group, an aromatic group, a heteroatom-containing substituent, a halogen atom-containing substituent, and a halogen atom; the substituent of carbon contained in X₁ and R₁ to R₅ are the same as or different from each other; and the compound is optionally a fused ring compound in which any of R₁ to R₅ are present in the same ring.
[2] The epoxy resin composition according to [1], wherein the component (D) is a compound represented by formula (2) below:

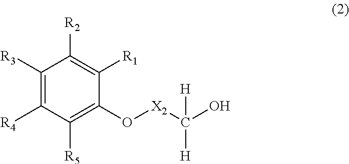

wherein X₂ has 2 or more and 4 or less consecutive carbon-carbon bonds, and a substituent of carbon contained in X₂ and R₁ to R₅ are each one selected from the group consisting of hydrogen, an alkyl group, an unsaturated aliphatic group, an aromatic group, a heteroatom-containing substituent, a halogen atom-containing substituent, and a halogen atom; the substituent of carbon contained in X₂ and R₁ to R₅ are the same as or different from each other; and the compound is optionally a fused ring compound in which any of R₁ to R₅ are present in the same ring.
[3] The epoxy resin composition according to [1] or [2], wherein the component (D) is a compound represented by formula (3) below:

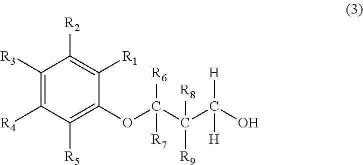

wherein R₁ to R₉ are each one selected from the group consisting of hydrogen, an alkyl group, an unsaturated aliphatic group, an aromatic group, a heteroatom-containing substituent, a halogen atom-containing substituent, and a halogen atom;
R₁ to R₉ are the same as or different from each other; and the compound is optionally a fused ring compound in which any of R₁ to R₅ are present in the same ring.
[4] The epoxy resin composition according to any one of [1] to [3], wherein the component (D) is a compound represented by formula (4) below:

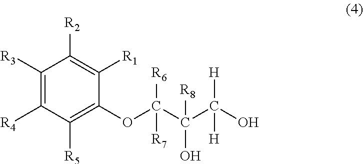

wherein R₁ to R₈ are each one selected from the group consisting of hydrogen, an alkyl group, an unsaturated aliphatic group, an aromatic group, a heteroatom-containing substituent, a halogen atom-containing substituent, and a halogen atom;
R₁ to R₈ are the same as or different from each other; and the compound is optionally a fused ring compound in which any of R₁ to R₅ are present in the same ring.
[5] The epoxy resin composition according to any one of [1] to [4], wherein the component (A) epoxy resin contains at least a bisphenol F epoxy resin.
[6] The epoxy resin composition according to any one of [1] to [5], wherein the component (B) microcapsular curing agent has a core circularity of 0.93 or more.
[7] The epoxy resin composition according to any one of [1] to [6], wherein the component (C) reactive diluent is a compound having an aromatic ring.
[8] The epoxy resin composition according to any one of [1] to [7], wherein the component (C) reactive diluent is a monofunctional compound in which the aromatic ring is monocyclic.
[9] The epoxy resin composition according to any one of [1] to [8], wherein a content of the component (C) reactive diluent is 1% by mass or more and 20% by mass or less in the epoxy resin composition.
[10] The epoxy resin composition according to any one of [1] to [9], wherein a content of the component (D) is 0.001% by mass or more and 5% by mass or less in the epoxy resin composition.
[11] The epoxy resin composition according to any one of [1] to [10], wherein R₁ to R₅ are free from an epoxy group and a structure of formula (5) below (terminal diol):

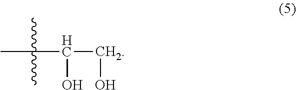 [SMILES: *C(O)CO]

[12] A film containing: a support; and a resin composition layer formed on the support and containing the epoxy resin composition according to any one of [1] to [11].
[13] The film according to [12], wherein the resin composition layer further contains a component (E): polymer for film formation.
[14] The film according to [12] or [13],
wherein the film is any one selected from the group consisting of an interlayer insulating film, a film type solder resist, a sealing sheet, an electroconductive film, an anisotropically electroconductive film, and a thermally conductive film.
[15] A method for producing the film according to any one of [12] to [14], the method containing:
a step of applying onto the support a preparation liquid containing at least the epoxy resin composition according to any one of [1] to [11] and a component (F) organic solvent, and then drying the component (F) organic solvent at a temperature range of 50 to 160° C. for a time range of 1 to 30 minutes.
[16] A cured product of the epoxy resin composition according to any one of [1] to [11].
[17] A cured product of the film according to any one of [12] to [14].

### Advantageous Effect of Invention

According to the present invention, an epoxy resin composition can be provided that is excellent in low viscosity, sufficient curability at around 100° C., and storage stability, and that is excellent in, when applied to films, stability during the film production process and stability in the film state.

### DESCRIPTION OF EMBODIMENTS

From now on, an embodiment for performing the present invention (hereinafter, referred to as “the present embodiment”) will be described in detail.

The following embodiment is an illustration for explaining the present invention and is not intended to limit the present invention to the following contents. The present invention can be performed with modifications as appropriate within the scope of its gist.

### [Epoxy Resin Composition]

An epoxy resin composition of the present embodiment contains:
a component (A): epoxy resin;
a component (B): microcapsular curing agent;
a component (C): reactive diluent; and
a component (D): compound represented by formula (1) below:

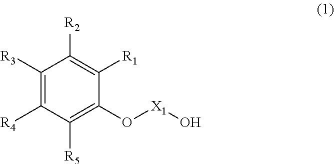

In formula (1), X₁ has 2 or more and 5 or less consecutive carbon-carbon bonds, and a substituent of carbon contained in X₁ and R₁ to R₅ are each one selected from the group consisting of hydrogen, an alkyl group, an unsaturated aliphatic group, an aromatic group, a heteroatom-containing substituent, a halogen atom-containing substituent, and a halogen atom. The substituent of carbon contained in X₁ and R₁ to R₅ are the same as or different from each other. The compound is optionally a fused ring compound in which any of R₁ to R₅ are present in the same ring.

### (Component (A): Epoxy Resin)

The epoxy resin composition of the present embodiment contains a component (A): epoxy resin (hereinafter, this may be referred to as (A) epoxy resin or component (A)).

Examples of the (A) epoxy resin include, but are not limited to: bifunctional epoxy resins such as bisphenol A epoxy resin, bisphenol F epoxy resin, bisphenol AD epoxy resin, bisphenol M epoxy resin, bisphenol P epoxy resin, tetrabromobisphenol A epoxy resin, biphenyl epoxy resin, tetramethylbiphenyl epoxy resin, tetrabromobiphenyl epoxy resin, diphenyl ether epoxy resin, benzophenone epoxy resin, phenyl benzoate epoxy resin, diphenyl sulfide epoxy resin, diphenyl sulfoxide epoxy resin, diphenylsulfone epoxy resin, diphenyl disulfide epoxy resin, naphthalene epoxy resin, anthracene epoxy resin, hydroquinone epoxy resin, methylhydroquinone epoxy resin, dibutylhydroquinone epoxy resin, resorcin epoxy resin, mehtylresorcin epoxy resin, and catechol epoxy resin; trifunctional epoxy resins such as N,N-diglycidylaminobenzene epoxy resin and triazine epoxy resin; tetrafunctional epoxy resins such as tetraglycidyldiaminophenylmethane epoxy resin and diaminobenzene epoxy resin; multifunctional epoxy resins such as phenol novolac epoxy resin, cresol novolac epoxy resin, triphenylmethane epoxy resin, tetraphenylethane epoxy resin, dicyclopentadiene epoxy resin, naphthol aralkyl epoxy resin, and brominated phenol novolac epoxy resin; and alicyclic epoxy resins.

One of these may be used alone, or two or more of them may be used in combination. Furthermore, for example, epoxy resins obtained by modifying the above with isocyanate or the like can be used in combination.

It is preferable that the epoxy resin composition of the present embodiment contains a bisphenol epoxy resin from the viewpoint of handleability and heat resistance, it is more preferable that it contains a bisphenol F epoxy resin from the viewpoint of imparting storage stability and good reactivity, and it is still more preferable that it further contains a bisphenol A epoxy resin from the viewpoint of imparting sufficient mechanical characteristics.

When the composition contains a bisphenol A epoxy resin in addition to a bisphenol F epoxy resin, it expresses superior storage stability and good reactivity. This mechanism is not intended to be limiting, but may be considered as follows. Since the containment of bisphenol A epoxy resin suppresses aggregation of bisphenol F epoxy resins, the uniformity of the epoxy resin composition of the present embodiment is improved and storage stability is improved, and since the diffusibility of molecules after the initiation of curing is enhanced, reactivity is also improved.

In the case where a bisphenol F epoxy resin and a bisphenol A epoxy resin are used in combination, the amount of the bisphenol F epoxy resin added is preferably 5 parts by mass or more, more preferably 15 parts by mass or more, still more preferably 25 parts by mass or more, even more preferably 30 parts by mass or more, and yet even more preferably 40 parts by mass or more, with respect to 100 parts by mass of the total of the bisphenol F epoxy resin and the bisphenol A epoxy resin, from the viewpoint of sufficiently expressing the above effects. Also, from the viewpoint of adding a bisphenol A epoxy resin in order to express sufficient mechanical characteristics, the amount of the bisphenol F epoxy resin added is preferably 90 parts by mass or less, more preferably 85 parts by mass or less, and still more preferably 80 parts by mass or less.

The total amount of chlorine contained in the (A) epoxy resin is preferably 2500 ppm or less, more preferably 2000 ppm or less, still more preferably 1500 ppm or less, and even more preferably 900 ppm or less, from the viewpoint of obtaining an epoxy resin composition that has excellent electrical characteristics and is excellent in the balance between curability and storage stability.

Also, the total amount of chlorine contained in the (A) epoxy resin is preferably 0.01 ppm or more, more preferably 0.02 ppm or more, still more preferably 0.05 ppm or more, even more preferably 0.1 ppm or more, yet even more preferably 0.2 ppm or more, and particularly preferably 0.5 ppm or more, from the viewpoint of achieving specific technical significance.

Here, the total amount of chlorine contained in the (A) epoxy resin refers to the total amount of organic chlorine and inorganic chlorine contained in the (A) epoxy resin, and is a value on a mass basis with respect to the (A) epoxy resin.

The total amount of chlorine of the (A) epoxy resin is measured by the following method.

The (A) epoxy resin is washed using xylene, and washing and filtration are repeated until there is no epoxy resin left in the washing solution, xylene. Next, the filtrate is distilled off under reduced pressure at 100° C. or lower to obtain the epoxy resin. A sample of 1 to 10 g of the obtained epoxy resin is accurately weighed to a titration volume of 3 to 7 mL, dissolved in 25 mL of ethylene glycol monobutyl ether, 25 mL of a solution of KOH in propylene glycol with a normality of 1 is added, the mixture is boiled for 20 minutes, and then titration is performed with an aqueous silver nitrate solution to obtain the titration volume, from which the total amount of chlorine can be calculated.

Here, among all chlorine, the chlorine contained in a 1,2-chlorohydrin group is generally referred to as hydrolyzable chlorine. The amount of hydrolyzable chlorine in the (A) epoxy resin is preferably 100 ppm or less, more preferably 50 ppm or less, still more preferably 0.01 or more and 20 ppm or less, and even more preferably 0.05 or more and 10 ppm or less. When the amount of hydrolyzable chlorine in the (A) epoxy resin is 100 ppm or less, it is advantageous from the viewpoint of achieving both high curability and storage stability in the epoxy resin composition of the present embodiment, and the cured product of the epoxy resin composition of the present embodiment tends to exhibit excellent electrical characteristics.

Here, hydrolyzable chlorine in the (A) epoxy resin is measured by the following method.

3 g of a sample is dissolved in 50 mL of toluene, 20 mL of a solution of KOH in methanol with a normality of 0.1 is added, the mixture is boiled for 15 minutes, and then titration is performed with an aqueous silver nitrate solution to obtain the titration volume, from which hydrolyzable chlorine can be calculated.

### (Component (B): Microcapsular Curing Agent)

The epoxy resin composition of the present embodiment contains a component (B): microcapsular curing agent (hereinafter, this may be referred to as (B) microcapsular curing agent or component (B)).

The (B) microcapsular curing agent is a curing agent at least having a core containing a curing agent component and a shell covering the core. Since the component (B) is microcapsular, the curing agent component is physically isolated from the (A) epoxy resin mentioned above, the component (C): reactive diluent mentioned later, and the component (D): specific compound mentioned later across the capsule membrane, and thus storage stability tends to be excellent.

### <Core>

The core constituting the (B) microcapsular curing agent may be any curing agent used for epoxy resins, and examples thereof include, but are not particularly limited to, an amine curing agent, an amide curing agent, a phenol curing agent, an acid anhydride curing agent, a catalytic curing agent, and modified products thereof. One of these may be used alone, or two or more of them may be used in combination.

Examples of the amine curing agent include, but are not limited to, an amine adduct type, a modified polyamine type, an aliphatic polyamine type, a heterocyclic polyamine type, an alicyclic polyamine type, an aromatic amine type, a polyamidoamine type, a ketimine type, and a urethane amine type.

Examples of the amide curing agent include, but are not limited to, dicyandiamide and a derivative thereof, guanidine compound, a compound formed by attaching an acid anhydride to an amine compound, and a hydrazide compound.

Examples of the hydrazide compound include, but are not limited to, succinic acid dihydrazide, adipic acid dihydrazide, phthalic acid dihydrazide, isophthalic acid dihydrazide, terephthalic acid dihydrazide, p-oxybenzoic acid hydrazide, salicylic acid hydrazide, phenylaminopropionic acid hydrazide, and maleic acid dihydrazide.

Examples of the guanidine compound include, but are not limited to, dicyandiamide, methylguanidine, ethylguanidine, propylguanidine, butylguanidine, dimethylguanidine, trimethylguanidine, phenylguanidine, diphenylguanidine, and toluylguanidine.

Examples of the phenol curing agent include, but are not limited to, phenol novolac resin, cresol novolac resin, phenol aralkyl resin, cresol aralkyl resin, naphthol aralkyl resin, biphenyl-modified phenolic resin, biphenyl-modified phenol aralkyl resin, dicyclopentadiene-modified phenolic resin, aminotriazine-modified phenolic resin, naphthol novolac resin, naphthol-phenol co-condensed novolac resin, naphthol-cresol co-condensed novolac resin, and allyl acrylic phenolic resin.

Examples of the acid anhydride curing agent include, but are not limited to, phthalic anhydride, trimellitic anhydride, pyromellitic anhydride, maleic anhydride, tetrahydrophthalic anhydride, methyltetrahydrophthalic anhydride, methylnadic anhydride, hexahydrophthalic anhydride, and methylhexahydrophthalic anhydride.

Examples of the catalytic curing agent include, but are not limited to, a cationic heat curing catalyst and a BF₃-amine complex.

Among the various curing agents mentioned above constituting the core, from the viewpoint of having moderate reactivity, an amine curing agent containing a low molecular weight amine compound (a1) and an amine adduct is preferred.

Examples of the low molecular weight amine compound (a1) constituting an amine curing agent include a compound having at least one primary amino group and/or secondary amino group but no tertiary amino group, and a compound having at least one tertiary amino group and at least one active hydrogen group.

Examples of the “compound having at least one primary amino group and/or secondary amino group but no tertiary amino group” include, but are not limited to, a primary amine having no tertiary amino group such as methylamine, ethylamine, propylamine, butylamine, ethylenediamine, propylenediamine, hexamethylenediamine, diethylenetriamine, triethylenetetramine, ethanolamine, propanolamine, cyclohexylamine, isophoronediamine, aniline, toluidine, diaminodiphenylmethane, and diaminodiphenylsulfone; and a secondary amine having no tertiary amino group such as dimethylamine, diethylamine, dipropylamine, dibutylamine, dipentylamine, dihexylamine, dimethanolamine, diethanolamine, dipropanolamine, dicyclohexylamine, piperidine, piperidone, diphenylamine, phenylmethylamine, and phenylethylamine.

Examples of the “compound having at least one tertiary amino group and at least one active hydrogen group” include, but are not limited to, an amino alcohol such as 2-dimethylaminoethanol, 1-methyl-2-dimethylaminoethanol, 1-phenoxymethyl-2-dimethylaminoethanol, 2-diethylaminoethanol, 1-butoxymethyl-2-dimethylaminoethanol, methyldiethanolamine, triethanolamine, and N-β-hydroxyethylmorpholine; an aminophenol such as 2-(dimethylaminomethyl)phenol and 2,4,6-tris(dimethylaminomethyl)phenol; an imidazole such as 2-methylimidazole, 2-ethyl-4-methylimidazole, 2-undecylimidazole, 2-heptadecylimidazole, 2-phenylimidazole, 1-aminoethyl-2-methylimidazole, 1-(2-hydroxy-3-phenoxypropyl)-2-methylimidazole, 1-(2-hydroxy-3-phenoxypropyl)-2-ethyl-4-methylimidazole, 1-(2-hydroxy-3-butoxypropyl)-2-methylimidazole, and 1-(2-hydroxy-3-butoxypropyl)-2-ethyl-4-methylimidazole; an imidazoline such as 1-(2-hydroxy-3-phenoxypropyl)-2-phenylimidazoline, 1-(2-hydroxy-3-butoxypropyl)-2-methylimidazoline, 2-methylimidazoline, 2,4-dimethylimidazoline, 2-ethylimidazoline, 2-ethyl-4-methylimidazoline, 2-benzylimidazoline, 2-phenylimidazoline, 2-(o-tolyl)-imidazoline, tetramethylene-bis-imidazoline, 1,1,3-trimethyl-1,4-tetramethylene-bis-imidazoline, 1,3,3-trimethyl-1,4-tetramethylene-bis-imidazoline, 1,1,3-trimethyl-1,4-tetramethylene-bis-4-methylimidazoline, 1,3,3-trimethyl-1,4-tetramethylene-bis-4-methylimidazoline, 1,2-phenylene-bis-imidazoline, 1,3-phenylene-bis-imidazoline, 1,4-phenylene-bis-imidazoline, and 1,4-phenylene-bis-4-methylimidazoline; a tertiary aminoamine such as dimethylaminopropylamine, diethylaminopropylamine, dipropylaminopropylamine, dibutylaminopropylamine, dimethylaminoethylamine, diethylaminoethylamine, dipropylaminoethylamine, dibutylaminoethylamine, N-methylpiperazine, N-aminoethylpiperazine, and diethylaminoethylpiperazine; an aminomercaptan such as 2-dimethylaminoethanethiol, 2-mercaptobenzimidazole, 2-mercaptobenzothiazole, 2-mercaptopyridine, and 4-mercaptopyridine; an aminocarboxylic acid such as N,N-dimethylaminobenzoic acid, N,N-dimethylglycine, nicotinic acid, isonicotinic acid, and picolinic acid; and an aminohydrazide such as N,N-dimethylglycine hydrazide, nicotinic acid hydrazide, and isonicotinic acid hydrazide.

Among these low molecular weight amine compounds (a1), from the viewpoint of having moderate reactivity, an imidazole is preferred.

Next, examples of the amine adduct constituting an amine curing agent include a compound having an amino group obtained by the reaction of each of a carboxylic acid compound, a sulfonic acid compound, a urea compound, an isocyanate compound, and an epoxy resin (e1), with an amine compound (a2).

Examples of the carboxylic acid compound include, but are not limited to, succinic acid, adipic acid, sebacic acid, phthalic acid, and dimeric acid.

Examples of the sulfonic acid compound include, but are not limited to, ethanesulfonic acid and p-toluenesulfonic acid.

Examples of the urea compound include, but are not limited to, urea, methylurea, dimethylurea, ethylurea, and t-butylurea.

Examples of the isocyanate compound include, but are not limited to, an aliphatic diisocyanate, an alicyclic diisocyanate, an aromatic diisocyanate, an aliphatic triisocyanate, and a polyisocyanate.

Examples of the aliphatic diisocyanate include, but are not limited to, ethylene diisocyanate, propylene diisocyanate, butylene diisocyanate, hexamethylene diisocyanate, and trimethylhexamethylene diisocyanate.

Examples of the alicyclic diisocyanate include, but are not limited to, isophorone diisocyanate, 4,4′-dicyclohexylmethane diisocyanate, norbornane diisocyanate, 1,4-isocyanatocyclohexane, 1,3-bis(isocyanatomethyl)-cyclohexane, and 1,3-bis(2-isocyanatopropyl-2-yl)-cyclohexane.

Examples of the aromatic diisocyanate include, but are not limited to, tolylene diisocyanate, 4,4′-diphenylmethane diisocyanate, xylene diisocyanate, and 1,5-naphthalene diisocyanate.

Examples of the aliphatic triisocyanate include, but are not limited to, undecane 1,6,11-triisocyanate, 1,8-diisocyanate-4-isocyanate methyl octane, and 1,3,6-triisocyanate methyl hexane.

Examples of the polyisocyanate include, but are not limited to, a polymethylene polyphenyl polyisocyanate and a polyisocyanate derived from the above diisocyanate compounds. Examples of the polyisocyanate derived from the above diisocyanate compounds include an isocyanurate type polyisocyanate, a biuret type polyisocyanate, a urethane type polyisocyanate, an allophanate type polyisocyanate, and a carbodiimide type polyisocyanate.

Examples of the epoxy resin (e1) include the compounds listed in the ((A) Epoxy resin) mentioned above.

As the amine compound (a2), the amine compounds listed above as examples of the low molecular weight amine compound (a1) constituting an amine curing agent can be used.

Among these amine adducts, in particular, one obtained by the reaction of the epoxy resin (e1) with the amine compound (a2) is preferred. The amine adduct obtained by the reaction of the epoxy resin (e1) with the amine compound (a2) is also preferred from the viewpoint that an unreacted amine compound (a2) can be diverted as the low molecular weight amine compound (a1).

It is preferable that, from the viewpoint of storage stability, the core component of the (B) microcapsular curing agent contains a curing agent that is solid at 25° C. and at 1013 hPa. This suppresses elution of the core component to the outside of the capsule even when damage occurs to the capsule during mixing of each component, thereby maintaining storage stability.

It is preferable that the average particle diameter of the core constituting the (B) microcapsular curing agent is larger than 0.3 μm and 12 μm or less. When the μaverage particle diameter of the core is larger than 0.3 m, aggregation of cores can be further prevented, formation of the (B) microcapsular curing agent becomes further easier, and the effect can be obtained that the storage stability of the epoxy resin composition of the present embodiment becomes sufficient for practical use. When the average particle diameter of the core is 12 μm or less, a homogeneous cured product can be obtained upon curing the epoxy resin composition of the present embodiment. In addition, when the average particle diameter of the core is 12 μm or less, generation of an aggregate having a large particle diameter can be prevented upon compounding to the epoxy resin composition of the present embodiment a diluting agent, a filler, a pigment, a dye, a flow modifier, a thickening agent, a reinforcement, a mold releasing agent, a wetting agent, a stabilizing agent, a flame retardant, a surfactant, an organic solvent, an electroconductive fine particle, a crystalline alcohol, another resin, or the like, and sufficient, long-term reliability of the cured product can be obtained. The average particle diameter of the core is preferably larger than 0.3 μm, more preferably 0.4 μm or more, and still more preferably 0.5 μm or more, as the lower limit value. The upper limit value is preferably 12 μm or less, more preferably 10 μm or less, and still more preferably 9 μm or less.

The average particle diameter of the core means an average particle diameter defined by the median diameter. More specifically, it means a Stokes' diameter measured by the laser diffraction light scattering method using a particle size analyzer (manufactured by HORIBA, Ltd., “HORIBA LA-920”).

Examples of the method for controlling the average particle diameter of the core to the numerical range mentioned above include, but are not limited to, a method in which precise control is carried out in a grinding step of a block-like curing agent; a method in which a rough grinding step and a fine grinding step are carried out as a grinding step of a block-like curing agent and the resulting particles are further classified using a precise classifying apparatus to obtain those with a desired average particle diameter; and a method in which a solution in which a block-like curing agent is dissolved in a solvent is spray dried.

For an apparatus used for grinding, for example, a ball mill, an attritor, a bead mill, a jet mill, or the like can be employed as necessary, but it is preferable to use an impact type grinding apparatus. Examples of the impact type grinding apparatus include a jet mill such as a swirling flow powder collision type jet mill and a powder collision type counter jet mill. The jet mill is an apparatus that allows solid materials to collide with each other through a high-speed jet stream using the air or the like as a medium, to provide fine particles. Examples of the method for carrying out precise control in a grinding step include a method in which the temperature, humidity, amount to be ground per unit time, and the like are controlled at the time of grinding. Examples of the method for classifying particles after grinding steps, using a precise classifying apparatus, to obtain those with a desired average particle diameter include a method in which classification is performed using a sieve (for example, a standard sieve of 325 mesh, 250 mesh, or the like) or a classifying machine, and a method in which classification is carried out through wind force depending on the specific gravity of particles, in order to obtain particulate objects with specific average particle diameters by the classification after the grinding. Examples of the classifying machine to be used include a wet type classifying machine and a dry type classifying machine, but in general, a dry type classifying machine is preferred. Examples of such a classifying machine include, but are not limited to, a dry type classifying apparatus such as “Elbow-Jet” manufactured by Nittetsu Mining Co., Ltd., “Fine Sharp Separator” manufactured by HOSOKAWA MICRON CORPORATION, “Variable Impactor” manufactured by SANKYO DENGYO Corporation, “Spadic classifier” manufactured by SEISHIN ENTERPRISE Co., Ltd., “Donaselec” manufactured by NIPPON DONALDSON, Ltd., “YM microcasette” manufactured by YASUKAWA & CO., LTD., and “Turbo Classifier” manufactured by Nisshin Engineering Inc., as well as other various air separators, micron separators, MicroPlex, and AcuCut.

Examples of the method for directly producing particles of a curing agent constituting the core, instead of grinding include a method in which a solution in which a block-like curing agent is dissolved in a solvent is spray dried. Specifically, examples thereof include a method in which a curing agent constituting the core is uniformly dissolved in an appropriate organic solvent, then sprayed in the solution state as fine droplets, and finally dried through hot wind or the like. Examples of the drying apparatus in this case include a normal spray drying apparatus.

Also, examples of the method for producing particles of a curing agent include a method in which a curing agent constituting the core is uniformly dissolved in an appropriate organic solvent, a poor solvent for the curing agent constituting the core is then added while vigorously stirring the uniform solution to deposit the curing agent constituting the core in the fine particle state. Then, the deposited particles are subsequently filtered and separated, and finally the solvents are dried and removed at a low temperature of the melting point of the curing agent constituting the core or below.

Examples of the method for adjusting the average particle diameter of a curing agent constituting the core in the particle state by an approach other than classification include a method in which the average particle diameter is adjusted by mixing a plurality of particles having different average particle diameters. For example, in the case of a curing agent with a large particle diameter, for which grinding and classification are hard, by adding another curing agent with a small particle diameter and mixing them together, a curing agent with an average particle diameter in the above-described range can be obtained.

The curing agent thus obtained may be further classified as necessary. Examples of such a mixing machine used for the purpose of mixing particulate matters include: a container rotary type mixing machine, which rotates the container itself in which particulate matters to be mixed are placed; a container fixed type mixing machine, which carries out mixing through mechanical agitation or air flow agitation without rotating the container itself in which particulate matters are placed; and a complex mixing machine, which rotates the container in which particulate matters are placed and carries out mixing also using another external force.

The shape of the core constituting the (B) microcapsular curing agent may be any of the following without limitation: granular, powdery, irregular, and a shape with irregular, rounded corners, for example.

It is preferable that the shape of the core constituting the (B) microcapsular curing agent is as close to a true sphere as possible. The closer the core is to a true sphere, the more evenly the capsule membrane, which is the shell mentioned later, is formed, and the component (B) tends to express low aggregation, excellent storage stability, and excellent solvent resistance. The degree of closeness to a true sphere is expressed as circularity, and the circularity of a true sphere is 1. The circularity of the core of the component (B) is preferably 0.93 or more, preferably 0.95 or more, and still more preferably 0.98 or more.

The circularity of the core constituting the (B) microcapsular curing agent can be measured by the flow type particle image analysis method. More specifically, the circularity can be determined by pouring the sample for measurement into a liquid, photographing the particles, determining the particle diameter from the projected area of the particles, and calculating the ratio between the perimeter of the projected image of the particles and the circumference of a circle equivalent to the particle diameter.

The method for controlling the circularity of the core is not particularly limited, but a method in which surface modification of a curing agent constituting the core is carried out is effective. Examples thereof include a method in which particles are mechanically rounded or treated with hot wind.

### <Shell>

It is preferable that the (B) microcapsular curing agent has a structure in which the surface of the core is covered by a shell containing a synthetic resin and/or an inorganic oxide. Among these, from the viewpoint of the stability and breakability upon heating of the membrane constituting the shell, as well as the uniformity of the cured product of the epoxy resin composition of the present embodiment, it is preferable that the shell constituting the (B) microcapsular curing agent contains a synthetic resin.

Examples of the synthetic resin contained in the shell include, but are not limited to, epoxy resin, phenolic resin, polyester resin, polyethylene resin, nylon resin, polystyrene resin, and urethane resin. Among these, the synthetic resin is preferably epoxy resin, phenolic resin, or urethane resin from the viewpoint of the balance between the stability and breakability upon heating of the membrane constituting the shell.

Examples of the epoxy resin used for the shell include, but are not limited to, an epoxy resin having two or more epoxy groups; a resin produced by the reaction between an epoxy resin having two or more epoxy groups and a compound having two or more active hydrogens; and a reaction product between a compound having two or more epoxy groups and a compound having one active hydrogen and a carbon-carbon double bond. Among these, from the viewpoint of stability, a resin produced by the reaction between a compound having two or more epoxy groups and a compound having two or more active hydrogens is preferred, and in particular, a reaction product between an amine curing agent and an epoxy resin having two or more epoxy groups is more preferred.

Examples of the phenolic resin include, but are not limited to, a phenol-formaldehyde polycondensate, a cresol-formaldehyde polycondensate, a resorcinol-formaldehyde polycondensate, a bisphenol A-formaldehyde polycondensate, and a polyethylenepolyamine-modified product of a phenol-formaldehyde polycondensate.

Examples of the polyester resin include, but are not limited to, an ethylene glycol-terephthalic acid-polypropylene glycol polycondensate, an ethylene glycol-butylene glycol-terephthalic acid polycondensate, and a terephthalic acid-ethylene glycol-polyethylene glycol polycondensate.

Examples of the polyethylene resin include, but are not limited to, an ethylene-propylene-vinyl alcohol copolymerized product, an ethylene-vinyl acetate copolymerized product, and an ethylene-vinyl acetate-acrylic acid copolymerized product.

Examples of the nylon resin include, but are not limited to, an adipic acid-hexamethylenediamine polycondensate, a sebacic acid-hexamethylenediamine polycondensate, and a p-phenylenediamine-terephthalic acid polycondensate.

Examples of the polystyrene resin include, but are not limited to, a styrene-butadiene copolymerized product, a styrene-butadiene-acrylonitrile copolymerized product, an acrylonitrile-styrene-divinylbenzene copolymerized product, and a styrene-propenyl alcohol copolymerized product.

Examples of the urethane resin include, but are not limited to, a polycondensate of an isocyanate monomer such as butyl isocyanate, cyclohexyl isocyanate, octadecyl isocyanate, phenyl isocyanate, tolylene diisocyanate, diphenylmethane diisocyanate, xylylene diisocyanate, hexamethylene diisocyanate, isophorone diisocyanate, tolidine diisocyanate, naphthalene diisocyanate, and triphenylmethane triisocyanate, or a condensates or polymer thereof, with a monoalcohol or a polyhydric alcohol. Among these, a urethane resin that is an addition polymerized product of a monoalcohol or a polyhydric alcohol with a monoisocyanate or a polyfunctional isocyanate is preferred.

Examples of the inorganic oxide include, but are not limited to, a boron compound such as boron oxide and a boric acid ester, silicon dioxide, and calcium oxide. Among these, from the viewpoint of the stability and breakability upon heating of the membrane constituting the shell, boron oxide is preferred.

Moreover, from the viewpoint of the balance between storage stability and curability of the epoxy resin composition of the present embodiment, it is preferable that the shell contains a reaction product of one or two or more selected from the group consisting of an isocyanate compound, an active hydrogen compound, a curing agent for epoxy resins, an epoxy resin, and an amine compound.

As the isocyanate compound, the isocyanate compounds listed above as examples of the starting material for the amine adduct contained in the core can be used.

Examples of the active hydrogen compound include, but are not limited to, water, a compound having at least one primary amino group and/or secondary amino group, and a compound having at least one hydroxy group. One of these active hydrogen compounds may be used alone, or two or more of them may be used in combination.

Examples of the compound having at least one primary amino group and/or secondary amino group include, but are not limited to, an aliphatic amine, an alicyclic amine, and an aromatic amine.

Examples of the aliphatic amine include, but are not limited to, an alkylamine such as methylamine, ethylamine, propylamine, butylamine, and dibutylamine; an alkylenediamine such as ethylenediamine, propylenediamine, butylenediamine, and hexamethylenediamine; a polyalkylenepolyamine such as diethylenetriamine, triethylenetetramine, and tetraethylenepentamine; and a polyoxyalkylenepolyamine such as polyoxypropylenediamine and polyoxyethylenediamine.

Examples of the alicyclic amine include, but are not limited to, cyclopropylamine, cyclobutylamine, cyclopentylamine, cyclohexylamine, and isophoronediamine.

Examples of the aromatic amine include, but are not limited to, aniline, toluidine, benzylamine, naphthylamine, diaminodiphenylmethane, and diaminodiphenylsulfone.

Examples of the compound having at least one hydroxy group include an alcohol compound and a phenol compound.

Examples of the alcohol compound include, but are not limited to, a monoalcohol such as methyl alcohol, propyl alcohol, butyl alcohol, amyl alcohol, hexyl alcohol, heptyl alcohol, octyl alcohol, nonyl alcohol, decyl alcohol, undecyl alcohol, lauryl alcohol, dodecyl alcohol, stearyl alcohol, eicosyl alcohol, allyl alcohol, crotyl alcohol, propargyl alcohol, cyclopentanol, cyclohexanol, benzyl alcohol, cinnamyl alcohol, ethylene glycol monomethyl ether, ethylene glycol monoethyl ether, and diethylene glycol monobutyl; a polyhydric alcohol such as ethylene glycol, polyethylene glycol, propylene glycol, polypropylene glycol, 1,3-butanediol, 1,4-butanediol, hydrogenated bisphenol A, neopentyl glycol, glycerin, trimethylolpropane, and pentaerythritol; and a polyhydric alcohol such as a compound having two or more secondary hydroxy groups per molecule, obtained by the reaction between a compound having at least one epoxy group and a compound having at least one hydroxy group, carboxy group, primary amino group, secondary amino group, or thiol group.

These alcohol compounds may be any of a primary alcohol, a secondary alcohol, and a tertiary alcohol.

Examples of the phenol compound include, but are not limited to, a monophenol such as carbolic acid, cresol, xylenol, carvacrol, thymol, and naphthol; and a polyhydric phenol such as catechol, resorcin, hydroquinone, bisphenol A, bisphenol F, pyrogallol, phloroglucin, 2-(dimethylaminomethyl)phenol, and 2,4,6-tris(dimethylaminomethyl)phenol.

For these compounds having at least one hydroxy group, from the viewpoint of latency and solvent resistance, a polyhydric alcohol and a polyhydric phenol are preferred, and a polyhydric alcohol is more preferred.

Reaction conditions for preparing a reaction product of one or two or more selected from the group consisting of an isocyanate compound, an active hydrogen compound, a curing agent for epoxy resins, an epoxy resin, and an amine compound contained in the shell constituting the (B) microcapsular curing agent as mentioned above are not particularly limited, and normally, the temperature range is −10° C. to 150° C. and the reaction time is 10 minutes to 12 hours.

The compounding ratio in the case where an isocyanate compound and an active hydrogen compound are used in order to prepare a reaction product contained in the shell is preferably in the range of 1:0.1 to 1:1000 as (isocyanate groups in the isocyanate compound):(active hydrogens in the active hydrogen compound) (equivalent ratio).

The reaction may be carried out in a specific dispersion medium as necessary.

Examples of the dispersion medium include a solvent, a plasticizing agent, and a resin.

Examples of the solvent include, but are not limited to, a hydrocarbon such as benzene, toluene, xylene, cyclohexane, mineral spirit, and naphtha; a ketone such as acetone, methyl ethyl ketone (MEK), and methyl isobutyl ketone (MIBK); an ester such as ethyl acetate, n-butyl acetate, and propylene glycol monomethyl ethyl ether acetate; an alcohol such as methanol, isopropanol, n-butanol, butyl cellosolve, and butyl carbitol; and water.

Examples of the plasticizing agent include, but are not limited to, a phthalic acid diester plasticizing agent such as dibutyl phthalate and di(2-ethylhexyl) phthalate; an aliphatic dibasic acid ester plasticizing agent such as di(2-ethylhexyl) adipate; a phosphoric acid triester plasticizing agent such as tricresyl phosphate; and a glycol ester plasticizing agent such as polyethylene glycol ester.

Examples of the resin include, but are not limited to, a silicone resin, an epoxy resin, and a phenolic resin.

Among the above, the reaction between an epoxy resin and a curing agent for epoxy resins is normally carried out at a temperature range of −10° C. to 150° C., preferably 0° C. to 100° C., for a reaction time of 1 hour to 168 hours, preferably 2 hours to 72 hours. In addition, for the dispersion medium, a solvent or a plasticizing agent is preferred.

Note that, in terms of % by mass in the shell, the reaction product contained in the shell, as mentioned above, is normally 1% by mass or more, preferably 50% by mass or more, and may be as high as 100% by mass.

In the (B) microcapsular curing agent, examples of the method for forming the shell covering the surface of the core include the following methods (1) to (3).
(1): A method in which the capsule components and the particles of curing agent are dissolved and dispersed in a solvent, which is a dispersion medium, and then, the solubility of the capsule components in the dispersion medium is reduced to deposit the capsule on the surface of the particles of curing agent for epoxy resins.
(2): A method in which the particles of curing agent are dispersed in a dispersion medium, and the materials for forming the above-described capsule are added to this dispersion medium to deposit the capsule on the particles of curing agent.
(3): A method in which the raw material components for forming the capsule are added to a dispersion medium, and the shell-forming materials are produced using the surface of the particles of curing agent as the reaction site.

Here, the methods (2) and (3) are preferred because reaction and coverage can be carried out at the same time.

Note that, in the methods (1) to (3), examples of the dispersion medium include a solvent, a plasticizing agent, and a resin. Moreover, for the solvent, plasticizing agent, and resin, those listed above as examples of the solvent, plasticizing agent, and resin that can be used upon preparing the reaction product of one or two or more selected from the group consisting of an isocyanate compound, an active hydrogen compound, a curing agent for epoxy resins, an epoxy resin, and an amine compound can be used.

The method for separating the (B) microcapsular curing agent from the dispersion medium after forming the shell by the method (2) or (3) is not particularly limited, but it is preferable that unreacted starting materials after the shell has been formed are separated and removed together with the dispersion medium. Examples of such a method include a method in which the dispersion medium and unreacted shell-forming materials are removed through filtration.

It is preferable to wash the microcapsular curing agent after the dispersion medium is removed. By washing the microcapsular curing agent, the unreacted shell-forming materials that attach to the surface thereof can be removed.

The method for washing is not particularly limited, but washing can be performed using the dispersion medium or a solvent in which the microcapsular curing agent is not dissolved when the curing agent is in the state of the residue by filtration. By drying the microcapsular curing agent after carrying out filtration and washing, the microcapsular curing agent in the form of powder can be obtained. The method for drying is not particularly limited, but it is preferable to perform drying at a temperature of the melting point or the softening point of the curing agent or below, and examples thereof include drying under reduced pressure. By making the microcapsular curing agent powdery, the operation for compounding with the (A) epoxy resin can be easily carried out. In addition, it is suitable to use an epoxy resin as the dispersion medium because simultaneously with formation of the shell, a masterbatch of the microcapsular curing agent integrated with the epoxy resin can be obtained.

Note that the reaction of forming the shell is normally carried out at a temperature range of −10° C. to 150° C., preferably 0° C. to 100° C., for a reaction time of 10 minutes to 72 hours, preferably 30 minutes to 24 hours.

Furthermore, from the viewpoint of the balance between storage stability and reactivity, it is preferable that the shell constituting the (B) microcapsular curing agent has a urea bond group, which absorbs infrared ray with a wave number of 1630 to 1680 cm⁻¹, a biuret bond group, which absorbs infrared ray with a wave number of 1680 to 1725 cm⁻¹, and a urethane bond group, which absorbs infrared ray with a wave number of 1730 to 1755 cm⁻¹.

The urea bond group, biuret bond group, and urethane bond group can be detected by measurement using a Fourier transform infrared spectrophotometer (hereinafter, this may be referred to as “FT-IR”). In addition, whether the shell has a urea bond group, a biuret bond group, or a urethane bond group can be confirmed with microscopic FT-IR.

Specifically, a modified aliphatic polyamine curing agent is added to the epoxy resin composition of the present embodiment to perform curing at 40° C. over 12 hours, and furthermore, the epoxy resin part is then completely cured at 120° C. over 24 hours. Subsequently, from the obtained cured product, a sample with a thickness of 5 to 20 μm is produced using an ultramicrotome, and it is analyzed in the depth direction of the shell with microscopic FT-IR. By observing the vicinity of the surface of the shell, the presence of a urea bond group, a biuret bond group, or a urethane bond group can be observed.

Moreover, the thickness of the shell constituting the (B) microcapsular curing agent is preferably 5 nm or more and 1000 nm or less, and more preferably 10 nm or more and 100 nm or less. When the thickness of the shell is 5 nm or more, the storage stability of the epoxy resin composition of the present embodiment can be further improved. In addition, when the thickness of the shell is 1000 nm or less, the curability can be further improved. Note that the thickness here means an average layer thickness, which can be measured with a transmission electron microscope.

From the viewpoint of imparting sufficient reactivity, when the (A) epoxy resin is defined as 100 parts by mass, the content of the (B) microcapsular curing agent in the epoxy resin composition of the present embodiment is preferably 1 part by mass or more, more preferably 5 parts by mass or more, still more preferably 10 parts by mass or more, even more preferably 20 parts by mass or more, and yet even more preferably 30 parts by mass or more.

In addition, from the viewpoints of suppressing aggregation of the (B) microcapsular curing agents, imparting sufficient mechanical strength to the cured product, and imparting sufficient storage stability to the epoxy resin composition, it is preferably 100 parts by mass or less, more preferably 90 parts by mass or less, still more preferably 80 parts by mass or less, even more preferably 75 parts by mass or less, and yet even more preferably 70 parts by mass or less.

### (Component (C): Reactive Diluent)

The epoxy resin composition of the present embodiment contains a component (C): reactive diluent (hereinafter, this may be referred to as (C) reactive diluent or component (C)).

The reactive diluent is a compound having an epoxy group or an acrylic group that can be incorporated into the cured structure, and its containment in the epoxy resin composition of the present embodiment has the effect of reducing the viscosity of the epoxy resin composition.

Examples of the (C) reactive diluent include, but are not limited to, a (meth)acrylate compound and an epoxy compound with which the viscosity can be reduced without impairing reactivity.

In the present specification, the reactive diluent is defined as a compound having a viscosity at 25° C. of 1 mPa·s or more and less than 3 Pa·s, excluding the compounds listed above as examples of the (A) epoxy resin.

In the epoxy resin composition of the present embodiment, an epoxy compound is preferred as the (C) reactive diluent from the viewpoint of being compatible with the (A) epoxy resin and the (B) microcapsular curing agent mentioned above and being incorporated into the cured structure after the reaction.

Examples of the (meth)acrylate compound used as the (C) reactive diluent include, but are not limited to, a compound having (meth)acryloyl groups at both terminals of a polyalkylene oxide, polyethylene glycol di(meth)acrylate, polypropylene glycol di(meth)acrylate, polybutylene glycol di(meth)acrylate, trimethylolpropane type polyfunctional (meth)acrylate, pentaerythritol type polyfunctional (meth)acrylate, dipentaerythritol type polyfunctional (meth)acrylate. Specifically, examples of the bifunctional (meth)acrylate compound having two or more aromatic rings include a compound in which a polyalkylene oxide is added to bisphenol A and both terminals have (meth)acrylate structures, and examples of the monofunctional (meth)acrylate compound having one aromatic ring include phenyl (meth)acrylate and ethylene glycol monophenyl ether (meth)acrylate.

Examples of the epoxy compound used as the (C) reactive diluent include, but are not limited to, an epoxy compound having no aromatic ring and an epoxy compound having an aromatic ring, as described below.

Examples of the monofunctional epoxy compound having no aromatic ring include a compound such as n-butyl glycidyl ether, t-butyl glycidyl ether, allyl glycidyl ether, and 2-ethylhexyl glycidyl ether.

Examples of the monofunctional epoxy compound having one or more aromatic rings include a compound such as styrene oxide, phenyl glycidyl ether, cresyl glycidyl ether, p-sec-butylphenyl glycidyl ether, t-butylphenyl glycidyl ether, and the trade name: SY-OPG manufactured by Sakamoto Yakuhin Kogyo Co., Ltd.

Examples of the bifunctional epoxy compound having no aromatic ring include a compound such as 1,4-cyclohexanedimethanol diglycidyl ether, 1,3-cyclohexanedimethanol diglycidyl ether, (3,4-epoxycyclohexyl)methyl-3,4-epoxycyclohexylcarboxylate, ethylene glycol diglycidyl ether, diethylene glycol diglycidyl ether, propylene glycol diglycidyl ether, 1,6-hexanediol diglycidyl ether, neopentyl glycol diglycidyl ether, dicyclopentadiene dimethanol diglycidyl ether, vinylcyclohexene dioxide, the trade name: YX-8000 manufactured by Mitsubishi Chemical Corporation, and the trade name: SR-8EGS manufactured by Sakamoto Yakuhin Kogyo Co., Ltd.

Examples of the bifunctional epoxy compound having one or more aromatic rings include a compound such as hexahydrophthalic acid diglycidyl ether, resorcinol diglycidyl ether, tert-butylhydroquinone diglycidyl ether, diglycidyl ether of polyoxyalkylene bisphenol A, N,N-diglycidylaniline, and N,N-diglycidyl-o-toluidine.

Examples of the trifunctional epoxy compound include trimethylolpropane triglycidyl ether, glycerin triglycidyl ether, and N,N-bis(2,3-epoxypropyl)-4-(2,3-epoxypropoxy)aniline.

In the epoxy resin composition of the present embodiment, it is preferable that the (C) reactive diluent has an aromatic ring from the viewpoint of enhancing solvent resistance. In addition, it is more preferable that the (C) reactive diluent is a monofunctional compound in which the aromatic ring is monocyclic, in particular, a monofunctional compound having any one of an epoxy group or an acrylic group as a functional group, from the viewpoint of further enhancing solvent resistance. Furthermore, it is still more preferable that the monofunctional group is an epoxy group from the viewpoint that the (C) component is incorporated into the cured product of the epoxy resin composition of the present embodiment after the reaction to express sufficient mechanical strength. Moreover, it is particularly preferred that the number of carbon atoms in each substituent of the aromatic ring is 3 or less from the viewpoint of improving penetration into the capsule membrane of the component (B) and improving solvent resistance, as will be mentioned later.

Meanwhile, it is preferable that the (C) reactive diluent is free from a nitrogen atom from the viewpoint of suppressing the reaction between the (C) reactive diluent and the (A) epoxy resin and enhancing storage stability.

The mechanism by which the (C) reactive diluent taking the structure mentioned above improves the solvent resistance of the epoxy resin composition of the present embodiment is not intended to be limiting, but may be considered as follows.

In the case where the (C) reactive diluent has an aromatic ring, the aromatic rings of the reactive diluent incorporated inside the shell of the (B) microcapsular curing agent express the stacking effect to form a network, thereby enhancing the aggregation strength of the shell. Accordingly, it is possible to construct a shell that is unlikely to be swollen, even against the solvent, and the solvent resistance of the epoxy resin composition of the present embodiment can be enhanced.

In addition, when the (C) reactive diluent is a monofunctional compound in which the aromatic ring is monocyclic, the steric hindrance is smaller, which facilitates penetration into the shell and enables formation of a denser stacking network of aromatic rings in a wider area. Here, when the number of carbon atoms in each substituent of the aromatic ring is 3 or less, the steric hindrance can be further reduced, the penetration into the shell can be enhanced, and the solvent resistance can be further improved.

From the viewpoint of imparting sufficient solvent resistance to the entire epoxy resin composition of the present embodiment, the amount of the (C) reactive diluent added is preferably 1% by mass or more, more preferably 3% by mass or more, still more preferably 4% by mass or more, even more preferably 5% by mass or more, and yet even more preferably 6% by mass or more. In addition, from the viewpoint of suppressing excessively low viscosity, deterioration of storage stability, and reduction of mechanical strength of the cured product, it is preferably 20% by mass or less, more preferably 15% by mass or less, still more preferably 13% by mass or less, even more preferably 12% by mass or less, and yet even more preferably 11% by mass or less.

### (Component (D): Compound Represented by Formula (1))

The epoxy resin composition of the present embodiment contains, as a component (D), a compound represented by formula (1) below (hereinafter, this may be referred to as component (D)).

When the epoxy resin composition of the present embodiment contains the component (D), the low viscosity and low temperature curability are improved while maintaining high storage stability, and furthermore, a sufficient curing region can be secured in the case of non-uniform heat transfer.

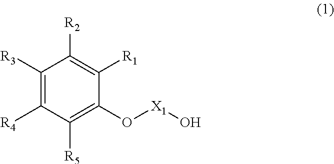

In formula (1), X₁ has 2 or more and 5 or less consecutive carbon-carbon bonds. A substituent of carbon contained in X₁ and R₁ to R₅ are each one selected from the group consisting of hydrogen, an alkyl group, an unsaturated aliphatic group, an aromatic group, a heteroatom-containing substituent, a halogen atom-containing substituent, and a halogen atom. The substituent of carbon contained in X₁ and R₁ to R₅ are the same as or different from each other. The compound is optionally a fused ring compound in which any of R₁ to R₅ are present in the same ring.

Examples of the compound represented by formula (1) above include, but are not limited to, 3-phenoxy-1-propanol, 3-phenoxy-1,2-propanediol, 3-phenoxy-1,3-propanediol, mephenesin (3-(o-tolyloxy)-1,2-propanediol), guaifenesin (3-(2-methoxyphenoxy)propane-1,2-diol), bisphenol A (3-hydroxypropyl) glycidyl ether, and bisphenol A (2,3-dihydroxypropyl) glycidyl ether, as well as the following compound 1, compound 2, and compound 3.

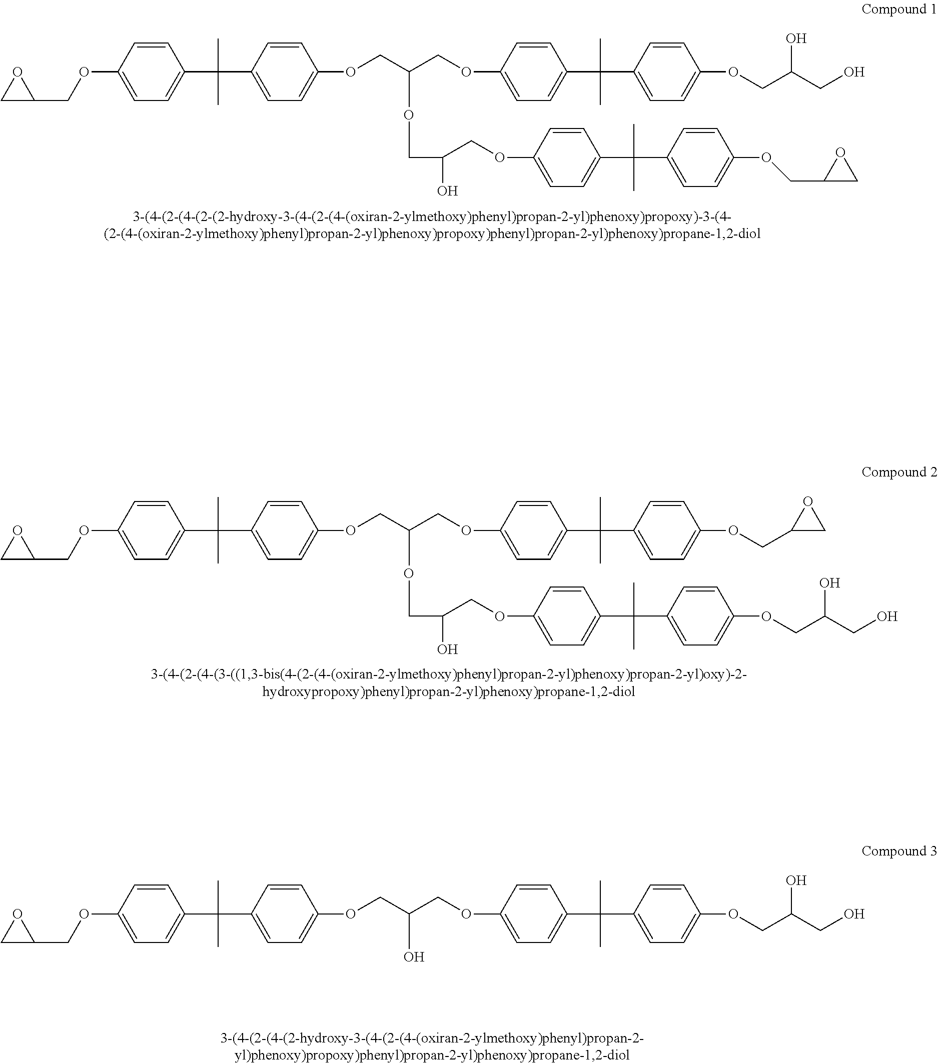 [SMILES: CC(C)(c1ccc(OCC(O)CO)cc1)c1ccc(OCC(COc2ccc(C(C)(C)c3ccc(OCC4CO4)cc3)cc2)OCC(O)COc2ccc(C(C)(C)c3ccc(OCC4CO4)cc3)cc2)cc1 ; CC(C)(c1ccc(OCC(O)CO)cc1)c1ccc(OCC(O)COC(COc2ccc(C(C)(C)c3ccc(OCC4CO4)cc3)cc2)COc2ccc(C(C)(C)c3ccc(OCC4CO4)cc3)cc2)cc1 ; CC(C)(c1ccc(OCC(O)CO)cc1)c1ccc(OCC(O)COc2ccc(C(C)(C)c3ccc(OCC4CO4)cc3)cc2)cc1]

The mechanism by which the component (D) improves the low viscosity and low temperature curability of the epoxy resin composition of the present embodiment and exhibits an effect in improving the curing region is not intended to be limiting, but may be considered as follows.

Interactions such as aromatic ring stacking and hydrogen bonds between the (A) epoxy resins are replaced by interactions between the (A) epoxy resin and the component (D) due to the aromatic group or hydroxyl group of the component (D), thereby eliminating the interactions between the (A) epoxy resins and facilitating molecular movement of the epoxy resin composition as a whole, resulting in lower viscosity. In addition, upon curing, formation of coordination bonds between the hydroxyl group of the component (D) and the curing agent component in the (B) microcapsular curing agent enhances the compatibility of the curing agent component and the (A) epoxy resin, which improves the diffusibility of the curing agent in the epoxy resin composition, enabling a more rapid reaction at a lower temperature. Furthermore, since the epoxy resin composition of the present embodiment contains the (C) reactive diluent, it is considered that the viscosity of the epoxy resin composition becomes even lower and the diffusibility described above is dramatically improved. Moreover, according to the mechanism described above, it is considered that an especially excellent improvement in reactivity is expressed in the case where the compatibility of the component (D), the (A) epoxy resin, and the (C) reactive diluent is good.

Also, in this mechanism, the component (D) acts catalytically in the reaction between the curing agent and the epoxy group until it is incorporated into the polymerized product.

The improved compatibility of the curing agent after the above-mentioned component (D) coordination, the (A) epoxy resin, and the (C) reactive diluent, and the improved component diffusibility also contribute to the improvement in the curing region. The effects on interactions, coordination, and compatibility are strongly influenced by the molecular structure. Accordingly, the epoxy resin composition of the present embodiment contains a compound represented by formula (1) above as the component (D).

From the viewpoint of suppressing the steric hindrance upon formation of coordination bonds with the curing agent component in the (B) microcapsular curing agent and expressing good curing characteristics, it is preferable that the component (D) is a compound represented by formula (2) below.

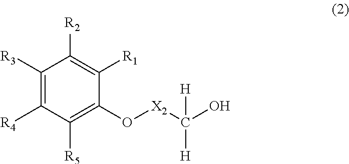

In formula (2), X₂ has 2 or more and 4 or less consecutive carbon-carbon bonds, and a substituent of carbon contained in X₂ and R₁ to R₅ are each one selected from the group consisting of hydrogen, an alkyl group, an unsaturated aliphatic group, an aromatic group, a heteroatom-containing substituent, a halogen atom-containing substituent, and a halogen atom. The substituent of carbon contained in X₂ and R₁ to R₅ are the same as or different from each other. The compound is optionally a fused ring compound in which any of R₁ to R₅ are present in the same ring.

From the viewpoint of good diffusibility into the epoxy resin after forming coordination bonds with the curing agent component in the (B) microcapsular curing agent, it is more preferable that the component (D) is a compound represented by formula (3) below, in which there are two consecutive carbon-carbon bonds.

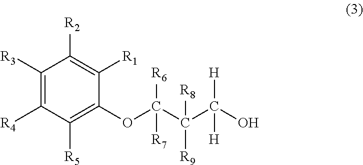

In formula (3), R₁ to R₉ are each one selected from the group consisting of hydrogen, an alkyl group, an unsaturated aliphatic group, an aromatic group, a heteroatom-containing substituent, a halogen atom-containing substituent, and a halogen atom.

R₁ to R₉ are the same as or different from each other. The compound is optionally a fused ring compound in which any of R₁ to R₅ are present in the same ring.

From the viewpoint of enhancing solvent resistance stability, stability at the time of film production, and film storage stability, it is still more preferable that the component (D) is a compound represented by formula (4) below, wherein R₉ in formula (3) above is a hydroxyl group.

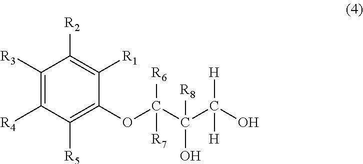

In formula (4), R₁ to R₈ are each one selected from the group consisting of hydrogen, an alkyl group, an unsaturated aliphatic group, an aromatic group, a heteroatom-containing substituent, a halogen atom-containing substituent, and a halogen atom.

R₁ to R₈ are the same as or different from each other. The compound is optionally a fused ring compound in which any of R₁ to R₅ are present in the same ring.

In addition, from the viewpoint of reducing steric hindrance in order to enhance coordination to the curing agent component, it is preferable that R₆, R₇, and R₈ of the compounds represented by formulas (3) and (4) above, component (D), are hydrogen atoms.

From the viewpoint of allowing the component (D) to act efficiently, it is preferable that R₁ to R₅ in the compounds represented by formulas (1) to (4) above of the component D are free from an epoxy group and a structure of formula (5) below (terminal diol structure).

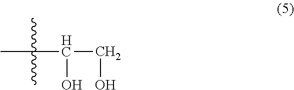 [SMILES: *C(O)CO]

When the compounds represented by formulas (1) to (4) above, component (D), are free from an epoxy group in R₁ to R₅, they are not incorporated into the curing reaction system and can act for a long period of time.

Also, when R₁ to R₅ have the structure of formula (5) above, two or more functional groups that are capable of coordination bonds with the curing agent are present in the molecules of the compounds of formulas (1) to (4) above in a positional relationship with less influence of steric hindrance, resulting in formation of coordination bonds between multiple molecules, which reduces molecular mobility. Therefore, it is preferable that R₁ to R₅ in the compounds of formulas (1) to (4) above are free from the structure of formula (5) above (terminal diol structure).

The sp value (6) is an indicator of compatibility, and in the case where the difference in sp value between compounds is small, good compatibility is indicated.

Since the excellent compatibility of the component (D) with the (A) epoxy resin and the (C) reactive diluent, and the excellent compatibility of the coordination compound formed by the coordination of the component (D) to the curing agent with the (A) epoxy resin and the (C) reactive diluent allow the effects of lower viscosity, improvement in low temperature curability, and improvement in curing region to be better demonstrated in the epoxy resin composition of the present embodiment, it is preferable that the sp value of the component (D) has a value close to the sp values of the (A) epoxy resin and the (C) reactive diluent.

The sp value of each compound at 25° C. is determined below by the Fedors calculation method (expression (i)), using the values described in Robert F. Fedors, Polymer Engineering and Science, February, 1974, Vol. 14, No. 2.

In the following expression, δ denotes the sp value.

$$δ = {( \sum Δ e / \sum Δ v )}^{1 / 2} \qquad expression ( i )$$

Δe denotes the aggregation energy for each substituent, and Av denotes the molar molecular volume.

### [Component (A)]

bisphenol A epoxy resin (n=0 form) . . . δ=10.9 (cal/cm³)^{1/2}
bisphenol F epoxy resin (n=0 form) . . . δ=12.1 (cal/cm³)^{1/2}
1,6-bis(2,3-epoxypropoxy)naphthalene . . . δ=13.1 (cal/cm³)^{1/2}

### [Component (C)]

phenyl glycidyl ether . . . δ=10.6 (cal/cm³)^{1/2}
o-cresyl glycidyl ether . . . δ=9.7 (cal/cm³)^{1/2}
1,6-hexanediol glycidyl ether . . . δ=9.8 (cal/cm³)^{1/2}

### [Component (D)]

3-phenoxy-1-propanol . . . δ=12.0 (cal/cm³)^{1/2}
3-phenoxy-1,2-propanediol . . . δ=14.3 (cal/cm³)^{1/2}
mephenesin . . . δ=13.0 (cal/cm³)^{1/2}
guaifenesin . . . δ=13.0 (cal/cm³)^{1/2}
bisphenol A (3-hydroxypropyl) glycidyl ether . . . δ=11.6 (cal/cm³)^{1/2}
bisphenol A (2,3-dihydroxypropyl) glycidyl ether . . . δ=12.9 (cal/cm³)^{1/2}
Compound 1 . . . δ=12.0 (cal/cm³)^{1/2}
Compound 2 . . . δ=12.0 (cal/cm³)^{1/2}
Compound 3 . . . δ=12.6 (cal/cm³)^{1/2}

From the viewpoint of better demonstrating the effects of lower viscosity, improvement in low temperature curability, and improvement in curing region of the epoxy resin composition of the present embodiment, in the case where the (A) epoxy resin and/or the (C) reactive diluent contains an epoxy resin with a sp value of 9 to 14 (cal/cm³)^{1/2}, the sp value of the component (D) is preferably 7 (cal/cm³)^{1/2} or more, more preferably 8 (cal/cm³)^{1/2} or more, still more preferably 9 (cal/cm³)^{1/2} or more, even more preferably 10 (cal/cm³)^{1/2} or more, and yet even more preferably 11 (cal/cm³)^{1/2} or more, as the lower limit value. The upper limit value is preferably less than 20 (cal/cm³)^{1/2}, more preferably 18 (cal/cm³)^{1/2} or less, and still more preferably 16 (cal/cm³)^{1/2} or less.

From the viewpoint of fully demonstrating the effects of lower viscosity and catalytic reactivity improvement of the epoxy resin composition of the present embodiment, the amount of the component (D) added is preferably 0.001% by mass or more, more preferably 0.005% by mass or more, still more preferably 0.01% by mass or more, and even more preferably 0.012% by mass or more, with respect to the entire epoxy resin composition. In addition, from the viewpoint of suppressing deterioration of storage stability due to excessive addition, it is preferably 5% by mass or less, more preferably 3% by mass or less, still more preferably 2.5% by mass or less, and even more preferably 2% by mass or less.

The component (D) may be added at the time of mixing with other components, may be produced in the system after mixing, or may be produced in the system upon producing the (A) epoxy resin, the (B) microcapsular curing agent, and the (C) reactive diluent.

### (Other Additives)

The epoxy resin composition of the present embodiment can further contain, besides the above-mentioned components, a curing agent other than the (B) microcapsular curing agent, as well as an organic filler, an inorganic filler, a pigment, a dye, a flow modifier, a thickening agent, a mold releasing agent, a wetting agent, a flame retardant, a surfactant, a resin, and the like as additives, as necessary.

Examples of the curing agent other than the (B) microcapsular curing agent include the curing agents and active ester compounds listed above as examples of the core component of the microcapsular curing agent.

The organic filler is capable of relaxing the stress generated by impact, and functions as an impact relaxant.

When the epoxy resin composition of the present embodiment contains the organic filler, adhesiveness with various connection members can be even further improved. Also, there is a tendency that the generation and progress of fillet cracks can be suppressed.

Examples of the organic filler include, but are not limited to, acrylic resin, silicone resin, butadiene rubber, polyester, polyurethane, polyvinyl butyral, polyarylate, polymethyl methacrylate, acrylic rubber, polystyrene, NBR, SBR, silicone modified resin, and organic fine particles of copolymers containing these as components.

From the viewpoint of improvement in adhesiveness, examples of the organic fine particles include an alkyl (meth)acrylate-butadiene-styrene copolymer, an alkyl (meth)acrylate-silicone copolymer, a silicone-(meth)acrylic copolymer, a complex of silicone and (meth)acrylic acid, a complex of alkyl (meth)acrylate-butadiene-styrene and silicone, and a complex of alkyl (meth)acrylate and silicone.

Also, as the aforementioned organic fine particles, organic fine particles having a core-shell type structure with compositions different between the core layer and the shell layer can be used. Examples of the core-shell type organic fine particles include particles with a core of silicone-acrylic rubber grafted with acrylic resin, and particles with acrylic copolymer grafted with acrylic resin.

One of these organic fillers may be used alone, or two or more of them may be used in combination.

The inorganic filler can adjust the thermal expansion coefficient of the epoxy resin composition of the present embodiment, and therefore, the containment of the inorganic filler tends to contribute to improvement in heat resistance and moisture resistance upon using the epoxy resin composition of the present embodiment as an underfill material.

Examples of the inorganic filler include, but are not limited to, a silicic acid salt such as talc, calcined clay, uncalcined clay, mica, and glass; an oxide such as titanium oxide, aluminum oxide (alumina), fused silica (for example, fused spherical silica and fused crushed silica), synthetic silica, and crystalline silica; a carbonic acid salt such as calcium carbonate, magnesium carbonate, and hydrotalcite; a hydroxide such as aluminum hydroxide, magnesium hydroxide, and calcium hydroxide; a sulfuric acid salt such as barium sulfate and calcium sulfate; a sulfurous acid salt such as calcium sulfite; a boric acid salt such as zinc borate, barium metaborate, aluminum borate, calcium borate, and sodium borate; and a nitride such as aluminum nitride, boron nitride, and silicon nitride.

Among these, fused silica, crystalline silica, and synthetic silica powder are preferred from the viewpoint that they can improve heat resistance, moisture resistance, and strength, and any of aluminum oxide and boron nitride are also preferred. By using these, the thermal linear expansion coefficient can be suppressed, which is anticipated to provide improvement in a cooling/heating cycle test.

The shape of the inorganic filler is not particularly limited and may have any form such as irregular, spherical, and scaly.

One of these inorganic fillers may be used alone, or two or more of them may be used in combination.

Examples of the pigment include, but are not limited to kaolin, aluminum oxide trihydrate, aluminum hydroxide, chalk powder, gypsum, calcium carbonate, antimony trioxide, penton, silica, aerosol, lithopone, barite, and titanium dioxide.

Examples of the dye include, but are not limited to a natural dye including a dye derived from plants such as a madder and an indigo plant, and a dye derived from minerals such as loess and red clay, and a synthetic dye such as alizarin and indigo, as well as a fluorescent dye.

Examples of the flow modifier include, but are not limited to an organic silane compound such as a silane coupling agent; an organic titanium compound such as titanium tetraisopropoxide and titanium diisopropoxybis(acetylacetonate); and an organic zirconium compound such as zirconium tetranormalbutoxide and zirconium tetraacetylacetonate.

Examples of the thickening agent include, but are not limited to, an animal thickening agent such as gelatin; a plant thickening agent such as polysaccharide and cellulose; and a chemical synthetic thickening agent such as polyacrylic thickening agent, modified polyacrylic thickening agent, polyether thickening agent, urethane-modified polyether thickening agent, and carboxymethyl cellulose.

Examples of the mold releasing agent include, but are not limited to, a fluorine mold releasing agent; a silicone mold releasing agent; and an acrylic mold releasing agent composed of a copolymer of glycidyl (meth)acrylate and a linear alkyl (meth)acrylate ester having 16 to 22 carbon atoms.

Examples of the wetting agent include, but are not limited to, an unsaturated polyester copolymer wetting agent having an acidic group, such as acrylic polyphosphoric acid ester.

Examples of the flame retardant include, but are not limited to, a metal hydroxide such as aluminum hydroxide and magnesium hydroxide; a halogen flame retardant such as a chlorine compound and a bromine compound; a phosphorus flame retardant such as a condensed phosphoric acid ester; an antimony flame retardant such as antimony trioxide and antimony pentoxide; and an inorganic oxide such as a silica filler.

Examples of the surfactant include, but are not limited to, an anionic surfactant such as an alkyl benzenesulfonic acid salt and an alkyl polyoxyethylene sulfuric acid salt; a cationic surfactant such as an alkyl dimethyl ammonium salt; an amphoteric surfactant such as an alkyl dimethyl amine oxide and an alkyl carboxy betaine; a nonionic surfactant such as a linear alcohol and a fatty acid ester having 25 or more carbon atoms.

Examples of the resin include, but are not limited to, silicone resin, phenolic resin, phenoxy resin, polyvinyl butyral resin, polyvinyl acetal resin, polyacrylic resin, and polyimide resin, as well as elastomer having a functional group such as carboxyl group, hydroxyl group, vinyl group, and amino group.

### [Method for Producing Epoxy Resin Composition]

The method for producing the epoxy resin composition of the present embodiment has a step of mixing the (A) epoxy resin, the (B) microcapsular curing agent, the (C) reactive diluent, and the compound of component (D) mentioned above to obtain the epoxy resin composition.

Mixing the (A) epoxy resin, the (C) reactive diluent, and the compound of component (D) in advance and then adding the (B) microcapsular curing agent, and mixing the (B) microcapsular curing agent, the (C) reactive diluent, and the compound of component (D) and then adding the (A) epoxy resin, as well as adding the (A) epoxy resin, the (B) microcapsular curing agent, the (C) reactive diluent, and the compound of component (D) to a masterbatch in which the (A) epoxy resin and the (B) microcapsular curing agent are integrated, are included in the method for producing the epoxy resin composition of the present embodiment, for example. There is no particular restriction on the method for mixing as well, and it can be selected as appropriate from, for example, a method using a planetary mixer and a method using a triple roll. Also, the (B) microcapsular curing agent may be produced by any of the methods mentioned above.

### [Method for Producing Curable Resin Composition]

The epoxy resin composition of the present embodiment can also be used as a masterbatch type epoxy resin curing agent to produce a curable resin composition. That is, by adding an epoxy resin, another curing agent, and other materials to the epoxy resin composition of the present embodiment, a curable resin composition can be produced. In such a case, the curable resin composition is also included in the embodiment of the present invention.

The curable resin composition can be obtained by thoroughly mixing the epoxy resin composition of the present embodiment with, for example, the (A) epoxy resin, the curing agents listed above as the core component of the (B) microcapsular curing agent, and those listed above as the other additives until uniform using a mixing roll such as triple roll, a dissolver, a planetary mixer, a kneader, an extruder, or other equipment.

For the epoxy resin composition of the present embodiment, the curable resin composition, and the epoxy resin composition preparation liquid for films mentioned later, heating treatment at a temperature of 30° C. to 80° C. for 1 to 168 hours can also be performed. There is no particular restriction on the heating method, but examples thereof include a method in which heating is performed in an oven, an incubator, a water bath, an oil bath, or the like. There is no particular restriction on the temperature history either, and for example, the temperature may be increased in stages or may be increased all at once.

By the heating treatment, reactions of excessive functional groups that react at a low temperature can be ceased.

### [Specific Aspects of Epoxy Resin Composition and Curable Resin Composition]

The epoxy resin composition of the present embodiment and the curable resin composition using the same are suitable for, but are not limited to, sealing materials for electrical and electronic components such as underfill materials and relay sealing materials, insulating materials, adhesives, electroconductive materials, matrix resins for fiber-reinforced plastics, and impregnating and fixing materials for motor coils.

For example, in underfill materials, low viscosity for rapid permeation between semiconductor chips and substrates, stability against heating at the time of permeation, and excellent curability at 100° C. or higher are required, and the epoxy resin composition of the present embodiment has all of these characteristics. Furthermore, the epoxy resin composition of the present embodiment is also suitable for larger area of semiconductor chips from the viewpoint of securing a sufficient curing region even in the case of non-uniform heat transfer.

Moreover, matrix resins for fiber-reinforced plastics and impregnating and fixing materials for motor coils are required to have permeability into fine fibers or coil gaps, stability at the time of permeation, and curability, and the epoxy resin composition of the present embodiment is suitable since it has all of these characteristics.

The curable resin composition using the epoxy resin composition of the present embodiment also has similar characteristics, and is therefore suitable for the above-mentioned aspects.

### (Film Containing Epoxy Resin Composition of the Present Embodiment)

A film of the present embodiment contains a resin composition layer that contains the epoxy resin composition of the present embodiment.

Upon this, the epoxy resin composition can also function as an epoxy resin curing agent or curing accelerator. The epoxy resin composition of the present embodiment is excellent in low viscosity, solvent resistance, storage stability, and curability, and is suitable for films.

The film of the present embodiment contains, for example, a specific support and a resin composition layer formed on the support from the epoxy resin composition preparation liquid mentioned later, and if necessary, may contain a protective layer on the surface opposite to the support of the resin composition layer.

### <Method for Preparing Epoxy Resin Composition Preparation Liquid for Films>

Examples of the method for preparing an epoxy resin composition preparation liquid for forming the resin composition layer of the film include a method in which the epoxy resin composition of the present embodiment is mixed with the (A) epoxy resin, the curing agents listed above as the core component of the (B) microcapsular curing agent, other additives, a component (E): polymer for film formation, and other components, and furthermore, a component (F): organic solvent is added, and mixing is performed with a planetary mixer or the like.

As the (E) polymer for film formation, any polymers can be used that have the effects of suppressing cracking, cissing, and excessive flow and maintaining the film shape upon applying the epoxy resin composition preparation liquid and then drying the organic solvent to form a film. Examples of such a component (E) include, but are not limited to, phenoxy resin, polyvinyl butyral resin, polyvinyl acetal resin, polyacrylic resin, and polyimide resin, as well as elastomer having a functional group such as carboxyl group, hydroxyl group, vinyl group, and amino group.

The (E) polymer for film formation may also be referred to as binder polymer.

There is no particular restriction on the (F) organic solvent, and any known organic solvent can be used. Examples thereof include, but are not limited to, a hydrocarbon such as toluene, xylene, cyclohexane, mineral spirit, and solvent naphtha; a ketone such as acetone, methyl ethyl ketone (MEK), and methyl isobutyl ketone (MIBK); an ester such as ethyl acetate, n-butyl acetate, and propylene glycol monomethyl ethyl ether acetate; an alcohol such as methanol, isopropanol, n-butanol, butyl cellosolve, and butyl carbitol; and an amide solvent such as dimethylformamide, dimethylacetamide, and N-methylpyrrolidone.

### <Support>

As the support, a material that can withstand a temperature at the time of drying the organic solvent is preferred. Examples of such a support include, but are not limited to, a polyethylene terephthalate film, a polyvinyl alcohol film, a polyvinyl chloride film, a vinyl chloride copolymer film, a polyvinylidene chloride film, a vinylidene chloride copolymer film, a polymethyl methacrylate copolymer film, a polystyrene film, a polyacrylonitrile film, a styrene copolymer film, a polyamide film, and a cellulose derivative film.

As these films, those that have been stretched can also be used, if necessary.

### <Protective Layer>

As the protective layer, a material is preferred that can sufficiently maintain the smoothness of the surface of the resin composition layer. As such a protective layer, although not limited to the following, a polyethylene film, a polypropylene film, a polyethylene terephthalate film that has been subjected to easy release treatment, an oriented polypropylene film, and the like can be preferably used.

### <Method for Producing Film>

The film of the present embodiment can be produced by sequentially laminating the support and the resin composition layer, as well as the protective layer, if necessary.

As the method for laminating the support, the resin composition layer, and the protective layer, known methods can be employed.

For example, a preparation liquid containing the epoxy resin composition of the present embodiment and the (F) organic solvent is prepared, and first applied onto the support using an applicator, bar coater, or any other known method, and dried to form the resin composition layer on the support. There is no particular restriction on the drying method, but examples thereof include oven or hot wind blowing. There is no particular restriction on the drying temperature or time either, but from the viewpoint of suppressing deformation of the support due to excessive heating and excess reaction of the resin composition layer at the time of drying while sufficiently removing the solvent, it is preferable to perform drying within a temperature range of 50° C. to 160° C. and a drying time of 1 minute to 30 minutes, and it is more preferable to perform drying at 80° C. to 150° C. for 3 minutes to 25 minutes. Note that the drying temperature may be a constant temperature or there may be a gradient in the temperature. Next, if necessary, the protective layer can be laminated on top of the formed resin composition layer to produce the film.

### <Specific Aspects of Film>

The film of the present embodiment can be utilized as, for example, but are not limited to, an interlayer insulating film, a film type solder resist, a sealing sheet, an electroconductive film, an anisotropically electroconductive film, a thermally conductive film, and the like.

Since the epoxy resin composition of the present embodiment is excellent in solvent resistance and storage stability, it is possible to extend the applicable time of the epoxy resin composition preparation liquid for films containing it, and also to extend the shelf life of the obtained film. In particular, it enables storage at refrigerated to near normal temperatures for films that are conventionally stored frozen in general.

In addition, since the epoxy resin composition of the present embodiment has low viscosity, it is easy to control the viscosity of the preparation liquid containing it, and the applicability onto the support is also excellent.

Furthermore, since the resin composition layer containing the epoxy resin composition of the present embodiment has sufficiently low viscosity due to heating at the time of film attachment and is also excellent in stability during the film production process and storage, the reaction of the epoxy compound after film production is suppressed and the low viscosity can be maintained for a long period of time. These characteristics allow the film of the present embodiment to have excellent irregularity followability and to be laminated to the substrate with no voids.

Moreover, since the epoxy resin composition of the present embodiment has excellent curability at around 100° C., the film of the present embodiment also has excellent curability.

The above characteristics are commonly required for interlayer insulating films, film type solder resists, sealing sheets, electroconductive films, anisotropically electroconductive films, and thermally conductive films, and therefore, the film of the present embodiment is suitable for these aspects.

### [Cured Product]

Cured products of the present embodiment are cured products of the above-mentioned epoxy resin composition of the present embodiment and film of the present embodiment.

The cured products of the present embodiment can be produced by performing heating treatment on the epoxy resin composition and film of the present embodiment.

The heating treatment can be performed by, for example, heating treatment in a heating furnace such as oven or thermocompression bonding. Also, there is no particular restriction on the heating conditions, which can be selected as appropriate depending on the compositional features of the epoxy resin composition and the heating treatment apparatus.

The cured products of the present embodiment are excellent in mechanical strength.

### EXAMPLES

Hereinafter, the present embodiment will be described with reference to specific Examples and Comparative Examples, but the present embodiment is not limited to the following Examples and Comparative Examples.

Note that, hereinafter, “part” and “%” are on the basis of mass unless otherwise indicated.

### [Method for Producing Microcapsular Curing Agent]

### Production Example 1

50 parts by mass of a bisphenol A epoxy resin A-1 (epoxy equivalent 186 g/eq, total amount of chlorine 600 ppm, amount of hydrolyzable chlorine 50 ppm, hereinafter referred to as “epoxy resin A-1”), 50 parts by mass of a bisphenol F epoxy resin A-2 (epoxy equivalent 172 g/eq, total amount of chlorine 500 ppm, amount of hydrolyzable chlorine 100 ppm, hereinafter referred to as “epoxy resin A-2”), 100 parts by mass of a curing agent core component b-1 (manufactured by Asahi Kasei Corp., solid amine adduct with a circularity of 0.93, hereinafter referred to as “core b-1”), and 10 parts by mass of an encapsulating agent c-1 (manufactured by Nippon Polyurethane Industry Co., Ltd.: MR-400) were added, dispersed and mixed, and then allowed to react at 55° C. for 5 hours to obtain a microcapsular curing agent B-1 dispersed in the epoxy resins.

### Production Example 2

50 parts by mass of the “epoxy resin A-1”, 50 parts by mass of the “epoxy resin A-2”, 100 parts by mass of the “core b-1”, and 10 parts by mass of an encapsulating agent c-2 (manufactured by Tosoh Corporation: T-80) were added, dispersed and mixed, and then allowed to react at 55° C. for 5 hours to obtain a microcapsular curing agent B-2 dispersed in the epoxy resins.

### Production Example 3

50 parts by mass of the “epoxy resin A-1”, 50 parts by mass of the “epoxy resin A-2”, 100 parts by mass of the “core component b-1”, 7 parts by mass of an encapsulating agent c-3 (manufactured by Tosoh Corporation: Coronate 1391), and 3 parts by mass of an encapsulating agent c-4 (manufactured by Asahi Kasei Corp.: Duranate TUL-100) were added, dispersed and mixed, and then allowed to react at 55° C. for 5 hours to obtain a microcapsular curing agent B-3 dispersed in the epoxy resins.

### [Preparation of Epoxy Resin Composition]

The (A) epoxy resin, the (B) microcapsular curing agent, the (C) reactive diluent, and the component (D): compound represented by formula (1) were each weighed, mixed, and the mixture was then filtered under conditions of 55° C. for 48 hours to obtain an epoxy resin composition such that the number of compounded parts was as shown in the component tables of Table 1 to Table 3 below.

The number of compounded parts of the (A) epoxy resin described in Table 1 to Table 3 below is the amount of epoxy resins in the entire epoxy resin composition, including the epoxy resins to be compounded simultaneously upon adding the “microcapsular curing agent dispersed in the epoxy resins” produced in Production Examples 1, 2, and 3. Accordingly, the number of compounded parts of the “(B) microcapsular curing agent” described in Table 1 to Table 3 below is the number of compounded parts of the microcapsular curing agent itself, which is composed of the core and the shell.

### [Measurement and Evaluation Method of Characteristics]

### (Measurement of Initial Viscosity of Epoxy Resin Composition)

Using an E-type viscometer (TVE-35H, manufactured by Toki Sangyo Co., Ltd.), the viscosity (initial viscosity) of the epoxy resin composition was measured immediately after being prepared at room temperature (25° C.).

From the viewpoints of sufficient gap permeability and appropriate production of the resin composition layer constituting the film, the initial viscosity was evaluated as follows: 4500 mPa·s or less is preferred, 3500 mPa·s or less is more preferred, and 3000 mPa·s or less is still more preferred.

### (Storage Stability: Storage Stability Viscosity Increasing Ratio)

The initial viscosity of the epoxy resin composition immediately after preparation and the viscosity after leaving the epoxy resin composition at 40° C. for 7 days were measured at room temperature (25° C.) using an E-type viscometer, and the storage stability viscosity increasing ratio was calculated according to expression (1) below.

$$Storage stability viscosity increasing ratio = Viscosity after leaving at 40 ° C . for 7 days / Initial viscosity \qquad expression ( 1 )$$

The storage stability viscosity increasing ratio was evaluated as follows: 1.2 or less is preferred, 1.1 or less is more preferred, and 1.0 is still more preferred.

(Temperature at which Dynamic Viscosity Reaches Specific Viscosity by Rheometer Measurement (Curability at Around 100° C.))

Using a rheometer (HAAKE MARS, manufactured by Thermo Scientific), a dynamic viscosity η′-temperature curve was obtained when the epoxy resin composition was heated from 25° C. to 200° C. at a temperature raising rate of 5° C./min and in oscillation mode (f=1 Hz).

From the obtained dynamic viscosity-temperature curve, the temperature at which the dynamic viscosity reaches 105 mPa·s: T (° C.) was confirmed.

Depending on the temperature: T (° C.), evaluation was performed as follows.
T≤95° C. . . . ⊚
95° C.<T≤105° C. . . . ◯
105° C.<T≤110° C. . . . Δ
110° C.<T . . . x

### (Curing Region)

The epoxy resin composition was poured fully up to the opening into a Teflon® mold with a length: 550 mm×width: 350 mm×thickness: 2 mm, and heated in a heating furnace at a set temperature of 100° C. for 25 minutes.

After completion of heating, the volume of the cured product removed from the Teflon® mold was defined as Vc, the volume into which the epoxy resin composition was poured was defined as V0, and the curing region was calculated according to expression (2) below.

$$Curing region ( \% ) = 100 \times Vc / V 0 \qquad expression ( 2 )$$

Depending on the proportion (%) of the curing region, evaluation was carried out according to the following criteria.
⊚ curing region: 100%
◯ curing region: 80% or more and less than 100%
Δ curing region: 50% or more and less than 80%
x curing region: less than 50%

The larger the curing region upon curing the epoxy resin composition, the superior it was evaluated to be from the viewpoint that a sufficient curing region can be secured even in the case where heat transfer in the curing region is insufficient.

That is, evaluation was shown in the table in the order of ⊚, ◯, Δ, and x from better to worse.

### (Solvent Resistance Stability)

Samples were prepared by mixing 80 parts by mass of the epoxy resin compositions of Examples 1 to 19 and Comparative Example 2 with 20 parts by mass of MEK (methyl ethyl ketone) as the solvent.

The obtained samples were heated at 50° C. and the time (h) until the flowability disappeared was measured.

The time until the flowability disappeared was evaluated as follows: 0.5 hours (h) or longer is preferred, 1 hour (h) is more preferred, and 2 hours (h) or longer is still more preferred.

### (Stability at the Time of Film Production Using Epoxy Resin Composition)

50 parts by mass of a phenoxy resin (manufactured by InChem Corporation, trade name “PKHB”), 50 parts by mass of a bisphenol A liquid epoxy resin (manufactured by Mitsubishi Chemical Corporation, trade name “jER828”), and 100 parts by mass of MEK were mixed and dissolved to obtain a solution, and to 100 parts by mass of this solution, 20 parts by mass of any of the epoxy resin compositions of Examples 1 to 19 and Comparative Example 2 were mixed to prepare epoxy resin composition preparation liquids for films.

These preparation liquids were applied onto a polyethylene terephthalate film (thickness 50 μm) as the support such that the dried film thickness was 40 μm, then heated and dried in an oven preheated to 120° C. for 5 minutes, and then the side opposite to the support was protected with a polyethylene terephthalate film that had been subjected to easy release treatment to obtain films. These are the films of Examples 20 to 38 and Comparative Example 4, respectively.

For the obtained films, the FT-IR spectrum was measured with a Fourier transform infrared spectrophotometer (FT/IR-6600, manufactured by JASCO Corporation).

The intensity ratio, P2/P1, of the absorption around 915 cm⁻¹ derived from the epoxy group, P2, with respect to the absorption around 2920 cm⁻¹ derived from the methylene group of the epoxy resins and phenoxy resin, which does not change in intensity caused by heating and drying, P1, was compared with the intensity ratio, P20/P10 (P10 is the absorption around 2920 cm⁻¹ and P20 is the absorption around 915 cm⁻¹ derived from the epoxy group), in the case where a film was produced in the same manner with compositional features in which the microcapsular curing agent component was omitted from the epoxy resin composition, which is the curing agent component, and the epoxy consumption rate was calculated using expression (3) below.

$$Exposy consumption rate = 100 - [ ( P 2 / P 1 ) / ( P 20 / P 10 ) ] \times 100 \qquad expression ( 3 )$$

Depending on the epoxy consumption rate, evaluation was performed according to the following criteria.
0%≤epoxy consumption rate<10% . . . ⊚
10%≤epoxy consumption rate<15% . . . ◯
15%≤epoxy consumption rate<20% . . . Δ
20%≤epoxy consumption rate . . . x

Evaluation was shown in the table in the order of ⊚, ◯, Δ, and x from better to worse.

### (Film Storage Stability Using Epoxy Resin Composition)

Films were produced by the same method as mentioned above (stability at the time of film production) using any of the epoxy resin compositions of Examples 1 to 19 and Comparative Example 2. Thereafter, the films were stored in an oven at 40° C. for 7 days. For the films after storage, the FT-IR spectrum was measured by the same method as described above (stability at the time of film production), and the post-storage epoxy consumption rate was calculated employing the post-storage value as the value of P2/P1 in expression (3) above. Depending on the post-storage epoxy consumption rate, evaluation was performed according to the following criteria.
0%≤epoxy consumption rate<10% . . . ⊚
10%≤epoxy consumption rate<15% . . . ◯
15%≤epoxy consumption rate<20% . . . Δ
20%≤epoxy consumption rate . . . x

Evaluation was shown in the table in the order of ⊚, ◯, Δ, and x from better to worse.

### (Stability at the Time of Film Production Using Epoxy Resin Composition as Curing Accelerator)

50 parts by mass of a phenoxy resin (manufactured by InChem Corporation, trade name “PKHB”), 50 parts by mass of a bisphenol A liquid epoxy resin (manufactured by Mitsubishi Chemical Corporation, trade name “jER828”), and 100 parts by mass of MEK were mixed and dissolved to obtain a solution, and to 100 parts by mass of this solution, 2.5 parts by mass of dicyandiamide (DICY) and 2 parts by mass of the epoxy resin compositions of Examples 1, 5, 10, and 15 were mixed as the curing component and the curing accelerator, respectively, to prepare epoxy resin material preparation liquids for films.

Using these preparation liquids, except that compositions in which the curing agent, dicyandiamide, and the microcapsular curing agent were omitted were used upon producing films for determining the P20/P10, films of Examples 39 to 42 were produced by the same method as mentioned above (stability at the time of film production) and the epoxy consumption rate measurement and evaluation were carried out.

Depending on the epoxy consumption rate, evaluation was performed according to the following criteria.
0%≤epoxy consumption rate<10% . . . ⊚
10%≤epoxy consumption rate<15% . . . ◯
15%≤epoxy consumption rate<20% . . . Δ
20%≤epoxy consumption rate . . . x

Evaluation was shown in the table in the order of ⊚, ◯, Δ, and x from better to worse.

### (Film Storage Stability Upon Using Epoxy Resin Composition as Curing Accelerator)

Using the epoxy resin compositions of Examples 1, 5, 10, and 15, films were produced by the same method as described above (stability at the time of film production upon using epoxy resin composition as curing accelerator).

Thereafter, the films were stored in an oven at 40° C. for 7 days. For the films after storage, the FT-IR spectrum was measured by the same method as described above (stability at the time of film production using epoxy resin composition as curing accelerator), and the post-storage epoxy consumption rate was calculated employing the post-storage value as the value of P2/P1 in expression (3) above.

Depending on the post-storage epoxy consumption rate, evaluation was performed according to the following criteria.
0%≤epoxy consumption rate<10% . . . ⊚
10%≤epoxy consumption rate<15% . . . ◯
15%≤epoxy consumption rate<20% . . . Δ
20%≤epoxy consumption rate . . . x

Evaluation was shown in the table in the order of ⊚, ◯, Δ, and x from better to worse.

### (Curability of Film)

Films were produced by the method mentioned above in (stability at the time of film production using epoxy resin composition) and (stability at the time of film production using epoxy resin composition as curing accelerator). Thereafter, the epoxy resin composition layer was transferred to an aluminum foil and cured in an oven at 180° C. for 1 hour.

The appearance and cross-section of the obtained cured product were observed to determine whether it was cured or not.

### [Component Description]

Hereinafter, the component (C) and the component (D) in Table 1 to Table 3 below are listed.

Note that the viscosity of the component (C) was measured by the same method as the initial viscosity measurement of the epoxy resin composition.

### Component (C):

PGE: phenyl glycidyl ether (viscosity at 25° C. of 6 mPa·s) (manufactured by Tokyo Chemical Industry Co., Ltd.)
o-CGE: o-cresyl glycidyl ether (viscosity at 25° C. of 7 mPa·s) (manufactured by Sigma-Aldrich Japan)
tBPGE: t-butylphenyl glycidyl ether (viscosity at 25° C. of 20 mPa·s) (manufactured by Tokyo Chemical Industry Co., Ltd.)
YED216D: 1,6-hexanediol diglycidyl ether (viscosity at 25° C. of 121 mPa·s) (trade name, manufactured by Mitsubishi Chemical Corporation)

### Component (D):

3-Phenoxy-1,2-propanediol (manufactured by Tokyo Chemical Industry Co., Ltd.)
Mephenesin (manufactured by Tokyo Chemical Industry Co., Ltd.)
3-Phenoxy-1-propanol (manufactured by Tokyo Chemical Industry Co., Ltd.)

### Other Component:

NEWPOL BPE-20: polyol compound in which ethylene oxide is added to bisphenol A (trade name, manufactured by Sanyo Chemical Industries, Ltd.)

### [Examples 1 to 19] and [Comparative Examples 1 to 3]

Each component was compounded in the proportions shown in Table 1 to Table 3, and epoxy resin compositions were prepared by the method described above.

Each characteristic of the prepared epoxy resin compositions was measured by the method described above.

TABLE 1

| | | Example | Example | Example | Example | Example |
|---|---|---|---|---|---|---|
| Component (parts by mass) | | 1 | 2 | 3 | 4 | 5 |
| Component A | A-1 | 50 | 50 | 50 | 50 | 50 |
| epoxy resin | A-2 | 50 | 50 | 50 | 50 | 50 |
| Component B | Production Example 1 | 50 | | | 50 | 50 |
| microcapsular curing | Production Example 2 | | 50 | | | |
| agent | Production Example 3 | | | 50 | | |
| Component C | PGE | 8 | 8 | 8 | | 17 |
| reactive diluent | o-CGE | | | | 8 | |
| | tBPGE | | | | | |
| | YED216D | | | | | |
| Component D | 3-Phenoxy-1,2- | 3 | 3 | 3 | 3 | 3 |
| | propanediol | | | | | |
| | Mephenesin | | | | | |
| | 3-Phenoxy-1-propanol | | | | | |
| Other component | NEWPOL BPE-20 | | | | | |
| Total | | 161 | 161 | 161 | 161 | 170 |
| Component C wt % | | 5.0% | 5.0% | 5.0% | 5.0% | 10.0% |
| Component D wt % | | 1.863% | 1.863% | 1.863% | 1.863% | 1.765% |
| Initial viscosity (mPa · s) | | 4305 | 4250 | 4520 | 4770 | 2430 |
| Storage stability viscosity | | 1.1 times | 1.1 times | 1.1 times | 1.1 times | 1.2 times |
| increasing ratio | | | | | | |
| Temperature at which dynamic | | ◯ | ◯ | ⊚ | Δ | ◯ |
| viscosity η′ reaches | | | | | | |
| 1.0 × 10\hat{ }5 mPa · s by | | | | | | |
| rheometer measurement | | | | | | |
| | | Example | Example | Example | Example | Example |
| Component (parts by mass) | | 6 | 7 | 8 | 9 | 10 |
| Component A | A-1 | 50 | 50 | 50 | 50 | 50 |
| epoxy resin | A-2 | 50 | 50 | 50 | 50 | 50 |
| Component B | Production Example 1 | 50 | 50 | | | 50 |
| microcapsular curing | Production Example 2 | | | | | |
| agent | Production Example 3 | | | 50 | 50 | |
| Component C | PGE | 8 | 8 | 17 | | 17 |
| reactive diluent | o-CGE | 9 | | | | |
| | tBPGE | | 9 | | 17 | |
| | YED216D | | | | | |
| Component D | 3-Phenoxy-1,2- | 3 | 3 | 3 | 3 | 0.02 |
| | propanediol | | | | | |
| | Mephenesin | | | | | |
| | 3-Phenoxy-1-propanol | | | | | |
| Other component | NEWPOL BPE-20 | | | | | |

| | | | | | |
|---|---|---|---|---|---|
| Total | 170 | 170 | 170 | 170 | 167.02 |
| Component C wt % | 10.0% | 10.0% | 10.0% | 10.0% | 10.2% |
| Component D wt % | 1.765% | 1.765% | 1.765% | 1.765% | 0.012% |
| Initial viscosity (mPa · s) | 2040 | 2910 | 2160 | 3430 | 2825 |
| Storage stability viscosity | 1.1 times | 1.0 times | 1.2 times | 1.1 times | 1.0 times |
| increasing ratio | | | | | |
| Temperature at which dynamic | ◯ | Δ | ⊚ | ⊚ | ◯ |
| viscosity η′ reaches | | | | | |
| 1.0 × 10\hat{ }5 mPa · s by | | | | | |
| rheometer measurement | | | | | |

TABLE 2

| | | Example | Example | Example | Example | Example |
|---|---|---|---|---|---|---|
| Component (parts by mass) | | 11 | 12 | 13 | 14 | 15 |
| Component A | A-1 | 50 | 50 | 75 | 25 | 50 |
| epoxy resin | A-2 | 50 | 50 | 25 | 75 | 50 |
| Component B | Production Example 1 | 50 | 50 | 50 | 50 | 50 |
| microcapsular | Production Example 2 | | | | | |
| curing agent | Production Example 3 | | | | | |
| Component C | PGE | 17 | 17 | 17 | 17 | 8 |
| reactive | o-CGE | | | | | |
| diluent | tBPGE | | | | | |
| | YED216D | | | | | |
| Component D | 3-Phenoxy- | 0.5 | | 3 | 3 | 0.02 |
| | 1,2-propanediol | | | | | |
| | Mephenesin | | 3 | | | |
| | 3-Phenoxy-1-propanol | | | | | |
| Other component | NEWPOL BPE-20 | | | | | |

| | | | | | |
|---|---|---|---|---|---|
| Total | 167.5 | 170 | 170 | 170 | 158.02 |
| Component C wt % | 10.1% | 10.0% | 10.0% | 10.0% | 5.1% |
| Component D wt % | 0.299% | 1.765% | 1.765% | 1.765% | 0.013% |
| Initial viscosity (mPa · s) | 2690 | 2455 | 2870 | 2160 | 4790 |
| Storage stability viscosity | 1.0 times | 1.1 times | 1.2 times | 1.0 times | 1.1 times |
| increasing ratio | | | | | |
| Temperature at which dynamic | ◯ | ◯ | ◯ | ◯ | Δ |
| viscosity η′ reaches | | | | | |
| 1.0 × 10\hat{ }5 mPa · s by | | | | | |
| rheometer measurement | | | | | |

| | | Example | Example | Example | Example |
|---|---|---|---|---|---|
| Component (parts by mass) | | 16 | 17 | 18 | 19 |
| Component A | A-1 | 50 | 50 | 50 | 50 |
| epoxy resin | A-2 | 50 | 50 | 50 | 50 |
| Component B | Production Example 1 | 50 | 50 | 50 | 50 |
| microcapsular | Production Example 2 | | | | |
| curing agent | Production Example 3 | | | | |
| Component C | PGE | 13 | | 8 | 17 |
| reactive | o-CGE | | 13 | | |
| diluent | tBPGE | | | | |
| | YED216D | | | 9 | |
| Component D | 3-Phenoxy- | 0.02 | | 3 | |
| | 1,2-propanediol | | | | |
| | Mephenesin | | 0.02 | | |
| | 3-Phenoxy-1-propanol | | | | 3 |
| Other component | NEWPOL BPE-20 | | | | |

| | | | | |
|---|---|---|---|---|
| Total | 163.02 | 163.02 | 170 | 170 |
| Component C wt % | 8.0% | 8.0% | 10.0% | 10.0% |
| Component D wt % | 0.012% | 0.012% | 1.765% | 1.765% |
| Initial viscosity (mPa · s) | 3150 | 4410 | 2270 | 1920 |
| Storage stability viscosity | 1.0 times | 1.0 times | 1.1 times | 1.2 times |
| increasing ratio | | | | |
| Temperature at which dynamic | ◯ | ◯ | ◯ | ◯ |
| viscosity η′ reaches | | | | |
| 1.0 × 10\hat{ }5 mPa · s by | | | | |
| rheometer measurement | | | | |

TABLE 3

| | | Comparative | Comparative | Comparative |
|---|---|---|---|---|
| Component (parts by mass) | | Example 1 | Example 2 | Example 3 |
| Component A | A-1 | 50 | 50 | 50 |
| epoxy resin | A-2 | 50 | 50 | 50 |
| Component B | Production Example 1 | 50 | 50 | 50 |
| microcapsular | Production Example 2 | | | |
| curing agent | Production Example 3 | | | |
| Component C | PGE | 8 | | 8 |
| reactive diluent | o-CGE | | | |
| | tBPGE | | | |
| | YED216D | | | |
| Component D | 3-Phenoxy-1,2-propanediol | | 3 | |
| | Mephenesin | | | |
| | 3-Phenoxy-1-propanol | | | |
| Other component | NEWPOL BPE-20 | | | 3 |

| | | | |
|---|---|---|---|
| Total | 158 | 153 | 161 |
| Component C wt % | 5.1% | 0.0% | 5.0% |
| Component D wt % | 0.000% | 1.961% | 0.000% |
| Initial viscosity (mPa · s) | 4880 | 12730 | 5010 |
| Storage stability viscosity increasing ratio | 1.1 times | 1.1 times | 1.2 times |
| Temperature at which dynamic viscosity η′ reaches | X | X | Δ |
| 1.0 × 10\hat{ }5 mPa · s by rheometer measurement | | | |

When comparing Examples and Comparative Examples 1 and 2, it was found that, by adding the component (C) and the component (D), low viscosity and improved reactivity were achieved while maintaining excellent storage stability, and epoxy resin compositions having an excellent balance of characteristics could be obtained.

When comparing Example 1 and Comparative Example 3, it was found that the compound having the structure of component (D) was effective in all of the following: storage stability, low viscosity, and improved reactivity.

When comparing Examples 1 and 4, it was found that the component (C) being PGE exhibited a superior balance of characteristics in low viscosity and reactivity.

When comparing Examples 5, 10, and 11, it was found that the larger the amount of the component (D), the superior the low viscosity tended to be, and the smaller the amount of the component (D), the superior the storage stability tended to be.

When comparing Examples 10, 15, and 16, it was found that, as the amount of the component (C) was increased, the curability and storage stability became superior. On the other hand, in the case of comparing Example 1 and Example 5, the storage stability was reduced as the amount of the component (C) was increased, but it was found that this was because the amount of the component (D) contained in Examples 10, 15, and 16 was more appropriate, and therefore, the influence of the component (D) on storage stability was smaller and the stacking of the component (C) in the shell could provide the effect of improving storage stability. In addition, since the viscosity was reduced along with the increase in the amount of the component (C), the diffusibility of the component (D) and the component (D) coordinating to the curing agent was improved at the time of the curing reaction, expressing excellent curability. Note that, when comparing Example 15 and Comparative Example 1, it was found that even a small amount of the component (D) was effective in improving reactivity, which indicates that the component (D) acts catalytically.

When comparing Examples 5, 13, and 14, it was found that, even when the ratio between bisphenol A epoxy resin and bisphenol F epoxy resin in the component (A) was changed, an epoxy resin composition having an excellent balance of characteristics could be obtained. It was also found that the higher the ratio of bisphenol F epoxy resin in the component (A), the superior the low viscosity and storage stability.

Table 4 shows the evaluation results of the curing region test.

TABLE 4

| | | | Comparative | Comparative |
|---|---|---|---|---|
| | Example 1 | Example 5 | Example 1 | Example 2 |
| Curing region | Δ | ⊚ | X | X |
| (100° C. × 25 min | | | | |
| curing) | | | | |

It was found that addition of the component (C) and the component (D) improved the curing region.

Table 5 and Table 6 show the evaluation results of the solvent resistance test.

TABLE 5

| | Example | Example | Example | Example | Example | Example | Example | Example | Example | Example |
|---|---|---|---|---|---|---|---|---|---|---|
| Component | 1 | 2 | 3 | 4 | 5 | 6 | 7 | 8 | 9 | 10 |
| Solvent | 0.5 h | 0.5 h | 0.5 h | 0.5 h | 2 h | 2 h | 1 h | 2 h | 1 h | 2 h |
| resistance | | | | | | | | | | |
| stability | | | | | | | | | | |
| solids:MEK = | | | | | | | | | | |
| 80:20 | | | | | | | | | | |
| flowability | | | | | | | | | | |
| evaluation | | | | | | | | | | |

TABLE 6

| | Example | Example | Example | Example | Example | Example | Example | Example | Example | Comparative |
|---|---|---|---|---|---|---|---|---|---|---|
| Component | 11 | 12 | 13 | 14 | 15 | 16 | 17 | 18 | 19 | Example 2 |
| Solvent | 2 h | 2 h | 2 h | 2 h | 0.5 h | 1.5 h | 1.5 h | 0.5 h | 1.5 h | Less than |
| resistance | | | | | | | | | | 0.25 h |
| stability | | | | | | | | | | |
| solids:MEK = | | | | | | | | | | |
| 80:20 | | | | | | | | | | |
| flowability | | | | | | | | | | |
| evaluation | | | | | | | | | | |

When comparing Examples and Comparative Example 2, it was found that addition of the component (C) improved solvent resistance.

When comparing Example 1 and Example 5, it was found that solvent resistance was improved by increasing the amount of the component (C) added.

In addition, when comparing Examples 5, 6, and 7 with Example 18, it was found that the component (C) being a compound having an aromatic ring provided superior solvent resistance. Furthermore, when comparing Examples 5 and 6 with Example 7, it was found that the component (C) being PGE and/or o-CGE exhibited superior solvent resistance compared to tBPGE. This is considered to be because the substituent of the aromatic ring with smaller steric hindrance brought about easier penetration into the capsule membrane, forming a denser aromatic ring stacking network.

Moreover, when comparing Examples 5 and 12 with Example 19, it was found that the component (D) being a compound with a diol structure at the terminal provided superior solvent resistance.

Table 7 and Table 8 show the test results of stability at the time of film production and film storage stability for the films of Examples 20 to 38 and Comparative Example 4, using the epoxy resin compositions of Examples 1 to 19 and Comparative Example 2.

TABLE 7

| | Example | Example | Example | Example | Example | Example | Example | Example | Example | Example | Example |
|---|---|---|---|---|---|---|---|---|---|---|---|
| | 20 | 21 | 22 | 23 | 24 | 25 | 26 | 27 | 28 | 29 | 30 |
| Epoxy resin | Example | Example | Example | Example | Example | Example | Example | Example | Example | Example | Example |
| composition | 1 | 2 | 3 | 4 | 5 | 6 | 7 | 8 | 9 | 10 | 11 |
| used | | | | | | | | | | | |
| Stability at | ◯ | ◯ | ◯ | ◯ | ⊚ | ⊚ | ◯ | ⊚ | ◯ | ⊚ | ⊚ |
| the time of | | | | | | | | | | | |
| film | | | | | | | | | | | |
| production | | | | | | | | | | | |
| Film storage | ◯ | ◯ | ◯ | ◯ | ⊚ | ⊚ | Δ | ⊚ | ◯ | ⊚ | ⊚ |
| stability | | | | | | | | | | | |

TABLE 8

| | Example | Example | Example | Example | Example | Example | Example | Example | Example | Example | Comparative |
|---|---|---|---|---|---|---|---|---|---|---|---|
| | 29 | 30 | 31 | 32 | 33 | 34 | 35 | 36 | 37 | 38 | Example 4 |
| Epoxy resin | Example | Example | Example | Example | Example | Example | Example | Example | Example | Example | Comparative |
| composition | 10 | 11 | 12 | 13 | 14 | 15 | 16 | 17 | 18 | 19 | Example 2 |
| used | | | | | | | | | | | |
| Stability at | ⊚ | ⊚ | ⊚ | ◯ | ⊚ | ◯ | ⊚ | ⊚ | Δ | ◯ | X |
| the time of | | | | | | | | | | | |
| film | | | | | | | | | | | |
| production | | | | | | | | | | | |
| Film storage | ⊚ | ⊚ | ⊚ | ◯ | ⊚ | ◯ | ⊚ | ⊚ | Δ | Δ | X |
| stability | | | | | | | | | | | |

When comparing Examples 20 to 38 with Comparative Example 4, it was found that addition of the component (C) resulted in superior stability at the time of film production and film storage stability.

When comparing Example 20 and Example 24, it was found that an increased amount of the component (C) added improved stability at the time of film production and film storage stability.

When comparing Examples 24, 25, and 26 with Example 37, it was found that the component (C) being a compound having an aromatic ring provided superior stability at the time of film production. In addition, when comparing Examples 24 and 25 with Example 26, it was found that the component (C) being PGE and/or o-CGE provided both superior stability at the time of film production and film storage stability compared to tBPGE.

When comparing Examples 24, 32, and 33, it was found that the more bisphenol F epoxy resin, the superior the stability at the time of film production and film storage stability tended to be.

Table 9 shows the test evaluation results of stability at the time of film production and film storage stability for the films of Examples 39 to 42, using the epoxy resin compositions of Examples 1, 5, 10, and 15 as the curing accelerator.

TABLE 9

| | Example 39 | Example 40 | Example 41 | Example 42 |
|---|---|---|---|---|
| Epoxy resin composition used | Example 1 | Example 5 | Example 10 | Example 15 |
| Stability at the time of film production | ⊚ | ⊚ | ⊚ | ⊚ |
| Film storage stability | ⊚ | ⊚ | ⊚ | ⊚ |

Examples 39 to 42 exhibited excellent stability at the time of film production and film storage stability.

Table 10 and Table 11 show the evaluation results of the curability test for the films of Examples 20 to 42.

TABLE 10

| | Example | Example | Example | Example | Example | Example | Example | Example | Example | Example |
|---|---|---|---|---|---|---|---|---|---|---|
| | 20 | 21 | 22 | 23 | 24 | 25 | 26 | 27 | 31 | 32 |
| Curability | Curable | Curable | Curable | Curable | Curable | Curable | Curable | Curable | Curable | Curable |

TABLE 11

| | Example | Example | Example | Example | Example | Example | Example | Example | Example | Example |
|---|---|---|---|---|---|---|---|---|---|---|
| | 33 | 34 | 35 | 36 | 37 | 38 | 39 | 40 | 41 | 42 |
| Curability | Curable | Curable | Curable | Curable | Curable | Curable | Curable | Curable | Curable | Curable |

All of the films of Examples 20 to 42 exhibited excellent curability.

Although the present embodiment has been described above, the present invention is not limited thereto, and can be modified as appropriate to the extent not to depart from the spirit of the invention.

The present application is based on the Japanese Patent Application filed on Jul. 12, 2021 (Japanese Patent Application No. 2021-114776) and the Japanese Patent Application filed on Aug. 18, 2021 (Japanese Patent Application No. 2021-133229), the contents of which are incorporated herein by reference.

### INDUSTRIAL APPLICABILITY

While the epoxy resin composition of the present invention has industrial applicability in insulating materials for electrical and electronic components such as underfills, sealing materials, adhesives, electroconductive materials, matrix resins for fiber-reinforced plastics, impregnating and fixing agents for motor coils, and the like, it also has industrial applicability in films using the epoxy resin composition of the present invention as a curing agent or a curing accelerator, such as interlayer insulating films, film type solder resists, sealing sheets, electroconductive films, anisotropically electroconductive films, and thermally conductive films, as well as in various paste materials such as insulating adhesive pastes, electroconductive pastes, anisotropically electroconductive pastes, and thermally conductive pastes, and various coating materials and paints that can take advantage of excellent solvent resistance.

1. An epoxy resin composition comprising:
a component (A): epoxy resin;
a component (B): microcapsular curing agent;
a component (C): reactive diluent; and
a component (D): compound represented by formula (1) below: 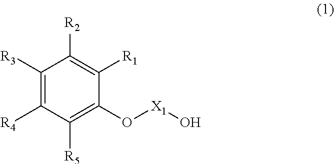
wherein X₁ has 2 or more and 5 or less consecutive carbon-carbon bonds, and a substituent of carbon contained in X₁ and R₁ to R₅ are each one selected from the group consisting of hydrogen, an alkyl group, an unsaturated aliphatic group, an aromatic group, a heteroatom-containing substituent, a halogen atom-containing substituent, and a halogen atom; the substituent of carbon contained in X₁ and R₁ to R₅ are the same as or different from each other;
and the compound is optionally a fused ring compound in which any of R₁ to R₅ are present in the same ring.

2. The epoxy resin composition according to claim 1,
wherein the component (D) is a compound represented by formula (2) below: 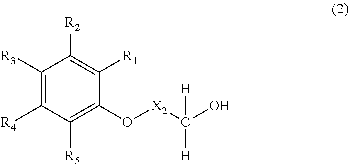
wherein X₂ has 2 or more and 4 or less consecutive carbon-carbon bonds, and a substituent of carbon contained in X₂ and R₁ to R₅ are each one selected from the group consisting of hydrogen, an alkyl group, an unsaturated aliphatic group, an aromatic group, a heteroatom-containing substituent, a halogen atom-containing substituent, and a halogen atom; the substituent of carbon contained in X₂ and R₁ to R₅ are the same as or different from each other; and the compound is optionally a fused ring compound in which any of R₁ to R₅ are present in the same ring.

3. The epoxy resin composition according to claim 1,
wherein the component (D) is a compound represented by formula (3) below: 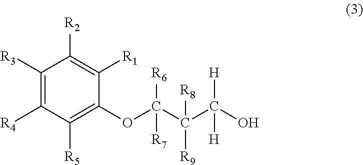
wherein R₁ to R₉ are each one selected from the group consisting of hydrogen, an alkyl group, an unsaturated aliphatic group, an aromatic group, a heteroatom-containing substituent, a halogen atom-containing substituent, and a halogen atom;
R₁ to R₉ are the same as or different from each other; and the compound is optionally a fused ring compound in which any of R₁ to R₅ are present in the same ring.

4. The epoxy resin composition according to claim 1,
wherein the component (D) is a compound represented by formula (4) below: 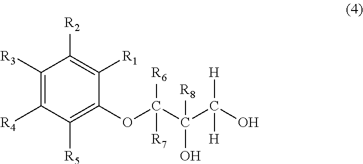
wherein R₁ to R₈ are each one selected from the group consisting of hydrogen, an alkyl group, an unsaturated aliphatic group, an aromatic group, a heteroatom-containing substituent, a halogen atom-containing substituent, and a halogen atom;
R₁ to R₈ are the same as or different from each other; and the compound is optionally a fused ring compound in which any of R₁ to R₅ are present in the same ring.

5. The epoxy resin composition according to claim 1,
wherein the component (A) epoxy resin contains at least a bisphenol F epoxy resin.

6. The epoxy resin composition according to claim 1,
wherein the component (B) microcapsular curing agent has a core circularity of 0.93 or more.

7. The epoxy resin composition according to claim 1,
wherein the component (C) reactive diluent is a compound having an aromatic ring.

8. The epoxy resin composition according to claim 1,
wherein the component (C) reactive diluent is a monofunctional compound in which the aromatic ring is monocyclic.

9. The epoxy resin composition according to claim 1,
wherein a content of the component (C) reactive diluent is 1% by mass or more and 20% by mass or less in the epoxy resin composition.

10. The epoxy resin composition according to claim 1,
wherein a content of the component (D) is 0.001% by mass or more and 5% by mass or less in the epoxy resin composition.

11. The epoxy resin composition according to claim 1,
wherein R₁ to R₅ are free from an epoxy group and a structure of formula (5) below (terminal diol):

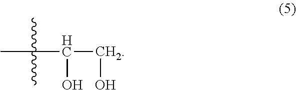 [SMILES: *C(O)CO]

12. A film comprising:
a support; and
a resin composition layer formed on the support and comprising the epoxy resin composition according to claim 1.

13. The film according to claim 12,
wherein the resin composition layer further comprises a component (E): polymer for film formation.

14. The film according to claim 12,
wherein the film is any one selected from the group consisting of an interlayer insulating film, a film type solder resist, a sealing sheet, an electroconductive film, an anisotropically electroconductive film, and a thermally conductive film.

15. A method for producing the film according to claim 12, the method comprising:
a step of applying onto the support a preparation liquid containing at least said epoxy resin composition and a component (F) organic solvent, and then drying the component (F) organic solvent at a temperature range of 50 to 160° C. for a time range of 1 to 30 minutes.

16. A cured product of the epoxy resin composition according to claim 1.

17. A cured product of the film according to claim 12.
